(19) United States
(12) Patent Application Publication
(10) Pub. No.: US 2016/0252675 A1
(43) Pub. Date: Sep. 1, 2016

(54) OPTICAL WAVEGUIDE, OPTICAL WAVEGUIDE MANUFACTURING METHOD, AND OPTICAL MODULE

(71) Applicants: Daichi Sakai, Ibaraki (JP); Yoshiaki Tsubomatsu, Ibaraki (JP); Toshihiro Kuroda, Tochigi (JP); Kazushi Minakawa, Ibaraki (JP); Hiroshi Betsui, Ibaraki (JP)

(72) Inventors: Daichi Sakai, Ibaraki (JP); Yoshiaki Tsubomatsu, Ibaraki (JP); Toshihiro Kuroda, Tochigi (JP); Kazushi Minakawa, Ibaraki (JP); Hiroshi Betsui, Ibaraki (JP)

(21) Appl. No.: 14/442,228

(22) PCT Filed: Nov. 12, 2013
(86) PCT No.: PCT/JP2013/080610

§ 371 Date: May 12, 2015

(30) Foreign Application Priority Data
Nov. 12, 2012 (JP) 2012-248705
Jul. 22, 2013 (JP) 2013-151689

(51) Int. Cl. G02B 6/122; G02B 6/136; G02B 6/42; G02B 6/13

(52) U.S. Cl. CPC G02B 6/122; G02B 6/13; G02B 6/136; G02B 6/423

(57) ABSTRACT

An optical waveguide is provided with a substrate 1, a lower cladding layer 2 that is formed on the substrate 1, an optical signal transmitting core pattern 31 and a protruding pattern 32 that are disposed on the lower cladding layer 2, and an upper cladding layer 4 that is disposed in a manner that it covers the optical signal transmitting core pattern 31 in association with the lower cladding layer 2. The protruding pattern 32 has an outer peripheral wall 33 that protrudes out of the substrate 1, the lower cladding layer 2, and the upper cladding layer 4 in an outer peripheral direction of the substrate 1.

This is a National Phase Application in the United States of International Patent Application No. PCT/JP2013/080610 filed Nov. 12, 2013, which claims priority on Japanese Patent Application Nos. 2012-248705, filed Nov. 12, 2012 and 2013-151689, filed Jul. 22, 2013. The entire disclosures of the above patent applications are hereby incorporated by reference.

### TECHNICAL FIELD

The present invention relates to an optical waveguide, an optical waveguide manufacturing method, and an optical module.

### BACKGROUND ART

In accordance with the increase in information volume, not only in the communication fields such as trunk lines and access paths, but also in the information processing of routers and servers, an optical interconnection technology that uses optical signals has been developing. In particular, as an optical transmission path that uses light for short-distance signal transmission among the boards of router and server devices or within the boards, optical waveguides are preferably used because of having a higher freedom in wiring and a capability of densification as compared with optical fibers. Among these, an optical waveguide that uses a polymer material, which is cost-effective and has an excellent processability, is promising.

As the optical waveguide, an optical waveguide in which a core pattern is formed on a lower cladding layer after the lower cladding layer is formed by curing on a substrate, and an upper cladding layer is laminated over the lower cladding layer and the core pattern has been proposed (for example, see Patent Document 1).

When the above optical waveguide is formed in a manner that a plurality of them are arrayed in a sheet form, the substrate and optical waveguides are required to be cut and individualized into pieces after the optical wave guides are formed.

In general, for cutting the substrate and waveguides, laser processing, cutting processing using dicing saws and routers, shearing processing using blade dies and metal dies, and the like are used.

### PRIOR ART DOCUMENTS

### Patent Documents

Patent Document 1: Japanese Patent Laid-Open Publication No. 2006-011210

### SUMMARY OF THE INVENTION

### Problems to be Solved by the Invention

However, the aforementioned processing methods have such disadvantages as: burrs generation caused by difference in processability between the substrate and the optical waveguide; inclination of edge faces; discontinuous formation of edge faces; and occurrence of peeling caused by poor adhesion between the substrate and the optical waveguide.

In addition, in an optical module in which the outer shape of the optical waveguide is used for positioning of connectors so as to couple the optical axes between optical waveguide cores and light receiving and emitting members (including light receiving and emitting elements and optical fibers), the core pattern and the outer shape are required to be formed with an accuracy of 10 μm or less. However, any processing method described above hardly provides a proper positioning accuracy to the core pattern. In an optical module having improper positioning accuracy, the optical axes of the optical waveguide cores and the light receiving and emitting members are displaced, thereby optical signal transmission efficiency is lowered.

The present invention has been performed to solve the aforementioned problems. It is an object of the present invention to provide an optical waveguide that has an excellent optical signal transmission efficiency and is easy to attain an optical axis connection to a connector of a separate member such as an optical fiber connector, an optical waveguide manufacturing method, and an optical module.

### Means for Solving the Problems

As a result of intensive studies of the present inventors for solving the aforementioned problems, it has been found that the problems are solved by an optical waveguide that has a protruding pattern exposed out of the substrate outer periphery. The present invention has been accomplished on the basis of the finding.

Namely, the present invention provides,

(1) an optical waveguide having a substrate, a lower cladding layer that is formed on the substrate, an optical signal transmitting core pattern and a protruding pattern that are formed on the lower cladding layer, and an upper cladding layer that is formed in a manner that it covers the optical signal transmitting core pattern in association with the lower cladding layer, wherein the protruding pattern has an outer peripheral wall that protrudes out of the substrate, the lower cladding layer, and the upper cladding layer in a substrate outer periphery direction,
(2) the optical waveguide as described in (1), wherein the outer peripheral wall is approximately perpendicular to the optical waveguide forming face,
(3) the optical waveguide as described in any of (1) and (2), wherein the protruding pattern holds the substrate outer periphery,
(4) the optical waveguide as describe in any of (1) to (3), wherein the lower cladding layer is a patterned lower cladding pattern and the end part of the lower cladding pattern is held by the protruding pattern,
(5) the optical waveguide as describe in any of (1) to (4), wherein the upper cladding layer is a patterned upper cladding pattern and the end part of the upper cladding pattern is held by the protruding pattern,
(6) the optical waveguide as described in any of (1) to (5), wherein the bottom face of the protruding pattern is formed on actually the same plane of the rear side of the optical waveguide forming face, or not on the rear side of the optical waveguide forming face but on the side of the optical waveguide forming face,
(7) an optical waveguide manufacturing method, including: a step A1 of forming a substrate on a part of a supporting substrate; a step B1 of forming a lower cladding pattern on the substrate; a step C1 of forming the protruding pattern on the substrate, the lower cladding pattern, and the surface of the supporting substrate by means of photolithographic processing in a manner that the substrate outer periphery is held; a step D1 of forming an upper cladding pattern at a position where the optical signal transmitting core pattern is embedded and the end part thereof is held by the protruding pattern; and a step E1 of removing the supporting substrate,
(8) an optical waveguide manufacturing method, including: a step A2 of not only forming a substrate on a part of a supporting substrate but also forming a peeling substrate on another part nearby the substrate; a step B1 of forming a lower cladding pattern on the substrate; a step C2 of forming the protruding pattern on the substrate, the lower cladding pattern, the surface of the supporting substrate, and the surface of the peeling substrate by means of photolithographic processing in a manner that the substrate outer periphery is held; a step D1 of forming an upper cladding pattern at a position where the optical signal transmitting core pattern is embedded and the end part thereof is held by the protruding pattern; and a step E1 of removing the supporting substrate,
(9) the optical waveguide manufacturing method as described in any of (7) and (8), including in order, prior to the step A1 or the step A2, a step of laminating a substrate sheet on a temporary fixing sheet and performing shape-processing of the substrate sheet into the shape of the substrate without cutting out the temporary fixing sheet, a step of laminating the supporting substrate on the surface of the substrate sheet, and a step of removing the temporary fixing sheet,
(10) the optical waveguide manufacturing method as described in any of (7) to (9), wherein, in the step C1 or the step C2, at the same time when the protruding pattern is formed, an optical signal transmitting core pattern is formed on the lower cladding pattern,
(11) the optical waveguide manufacturing method as described in any of (7) to (10), including a step F of removing the peeling substrate at the same time or after the step E1,
(12) an optical waveguide manufacturing method, including: a step B2 of forming a lower cladding layer on a substrate; a step C3 of forming a stretching optical signal transmitting core pattern on the lower cladding layer and forming a protruding pattern in a manner that the optical signal transmitting core pattern is positioned therebetween; a step D2 of forming an upper cladding pattern in a manner that, among the side faces of the protruding pattern, a side face that does not face to the side face of the optical signal transmitting core pattern is exposed and that the optical signal transmitting core pattern is embedded; and a step E2 of removing the substrate and lower cladding layer under the protruding pattern, or removing the substrate,
(13) an optical waveguide manufacturing method, including: a step B1 of forming a lower cladding pattern on a substrate; a step C4 of forming a stretching optical signal transmitting core pattern on the lower cladding pattern and forming a protruding pattern on the substrate and/or the lower cladding pattern in a manner that the optical signal transmitting core pattern is positioned therebetween; a step D2 of forming an upper cladding pattern in a manner that, among the side faces of the protruding pattern, a side face that does not face to the side face of the optical signal transmitting core pattern is exposed and that the optical signal transmitting core pattern is embedded; and a step E3 of removing the substrate and lower cladding pattern under the protruding pattern, or removing the substrate,
(14) the optical waveguide manufacturing method as described in (13), wherein the protruding pattern is formed in a manner that the end part of the lower cladding pattern is held,
(15) the optical waveguide manufacturing method as described in any of (12) to (14), wherein the optical signal transmitting core pattern and the protruding pattern are formed at the same time,
(16) the optical waveguide manufacturing method as described in any of (12) to (15), wherein the optical signal transmitting core pattern and the protruding pattern are formed by means of photolithographic processing,
(17) the optical waveguide manufacturing method as described in any of (12) to (16), wherein the upper cladding pattern is formed by means of photolithographic processing,
(18) the optical waveguide manufacturing method as described in any of (12) to (17), wherein, in the step E2 or the step E3, in the protruding pattern, a side face that is not covered with the upper cladding pattern is served as an outer peripheral wall of the optical waveguide,
(19) the optical waveguide manufacturing method as described in any of (12) to (18), wherein, in the step E2 or the step E3, removing is performed by means of dicing processing,
(20) the optical waveguide manufacturing method as described in any of (12) to (19), wherein, in the step E2 or the step E3, dicing processing is performed in a manner that resulting cross section has an approximately rectangular or triangular shape,
(21) the optical waveguide manufacturing method as described in any of (12) to (20), wherein, in the step E2 or the step E3, under the protruding pattern, at least a part of the substrate and/or the lower cladding pattern remains, and
(22) an optical module, in which an optical waveguide as described in any of (1) to (6) and a connector are fitted to each other by using an outer peripheral wall of the protruding pattern.

### Effect of the Invention

In accordance with the present invention, an optical waveguide that is easy to achieve an optical axis connection to a connector of a separate member such as an optical fiber connector and has an excellent optical signal transmission efficiency, an optical waveguide manufacturing method, and an optical module are provided.

### BRIEF DESCRIPTION OF DRAWINGS

FIG. 1 is a cross sectional view showing an embodiment of an optical waveguide according to a first embodiment of the present invention.

FIG. 2 is a cross sectional view of process showing an optical waveguide manufacturing method according to the first embodiment of the present invention.

FIG. 3 is a cross sectional view showing an embodiment of an optical waveguide according to a second embodiment of the present invention.

FIG. 4 is a cross sectional view of process showing an optical waveguide manufacturing method according to the second embodiment of the present invention.

FIG. 5 is a cross sectional view showing an embodiment of an optical waveguide according to a third embodiment of the present invention.

FIG. 6 is a cross sectional view of process showing an optical waveguide manufacturing method according to the third embodiment of the present invention.

FIG. 7 is a cross sectional view showing an embodiment of an optical waveguide according to a forth embodiment of the present invention.

FIG. 8 is a cross sectional view of process showing an optical waveguide manufacturing method according to the forth embodiment of the present invention.

FIG. 9 is a cross sectional view showing an embodiment of an optical waveguide according to a fifth embodiment of the present invention.

FIG. 10 is a cross sectional view of process showing an optical waveguide manufacturing method according to the fifth embodiment of the present invention.

FIG. 11 is a cross sectional view showing an embodiment of an optical waveguide according to a sixth embodiment of the present invention.

FIG. 12 is a cross sectional view of process showing an optical waveguide manufacturing method according to the sixth embodiment of the present invention.

FIG. 13 is a cross sectional view showing an embodiment of an optical waveguide according to a seventh embodiment of the present invention.

FIG. 14 is a cross sectional view of process showing an optical waveguide manufacturing method according to the seventh embodiment of the present invention.

FIG. 15 is a cross sectional view showing an embodiment of an optical waveguide according to an eighth embodiment of the present invention.

FIG. 16 is a cross sectional view of process showing an optical waveguide manufacturing method according to the eighth embodiment of the present invention.

FIG. 17 is a plan view showing a manufacturing method in relation to Example 1 of the present invention.

FIG. 18 is a plan view showing a manufacturing method in relation to Example 2 of the present invention.

### MODE FOR CARRYING OUT THE INVENTION

### First Embodiment

An optical waveguide according to the first embodiment of the present invention is, as shown in FIG. 1, provided with a substrate 1, a lower cladding layer 2 (lower cladding pattern 21) that is disposed on the optical waveguide forming face 13 of the substrate 1, an optical signal transmitting core pattern 31 that is disposed on the lower cladding layer 2, an upper cladding layer 4 (upper cladding pattern 41) that is disposed in a manner that the optical signal transmitting core pattern 31 is covered therewith in association with the lower cladding layer 2, and a protruding pattern 32 that has an outer peripheral wall 33 at a position protruding out of a substrate outer periphery 11 of the substrate 1.

Substrate

The substrate 1 provides the optical waveguide with toughness. In addition, the substrate 1 is allowed to suppress breakage of the optical waveguide when an optical path conversion mirror is formed in the optical waveguide by using a dicing saw and the like. Furthermore, in the case of forming a multi-channel optical signal transmitting core pattern 31 on the lower cladding pattern 21 (lower cladding layer 2), shrinkage of the optical waveguide is allowed to be suppressed and pitches of the optical signal transmitting core pattern 31 are allowed to be kept satisfactorily. Furthermore, the substrate 1 is allowed to suppress breakage of a protruding portion 5 when a supporting substrate 6 and a peeling substrate 7 in the protruding portion 5 are physically delaminated in the course of production steps (step E1 and step F which are described later). This is because the protruding pattern 32 is allowed to be nipped and held with the lower cladding pattern 21 and the upper cladding pattern 41. Furthermore, the substrate 1 is allowed to suppress breakage of the protruding portion 5 when the optical waveguide is fitted to a connector.

Examples of the material for the substrate 1, considering the above, include: a glass epoxy resin substrate; a ceramic substrate; a glass substrate; a silicon substrate; a plastics substrate; a metal substrate; a resin layered substrate that has a resin layer formed on each of the foregoing substrates; a metal layered substrate that has a metal layer formed on each of the foregoing substrates; and an electric wiring board.

The thickness of the substrate 1 is not particularly limited, but in the case of expecting a rigid optical waveguide, 50 μm or more is advantageous because satisfactory strength as a rigid substrate 1 may be easily attained. In 2000 μm or less, a low height optical waveguide may be attained. Considering the above, the thickness of the substrate 1 is preferably in a range of 50 μm or more and 2000 μm or less and more preferably in a range of 60 μm or more and 1000 μm or less.

When flexibility is expected to be imparted to the optical waveguide, for the substrate 1, a material that has flexibility and toughness is preferably used. Examples of the substrate 1 that has flexibility and toughness include preferably: polyester such as polyethylene terephthalate, polybutylene terephthalate, and polyethylene naphthalate; polyethylene; polypropylene; polyamide; polycarbonate; polyphenylene ether; polyether sulfide; polyallylate; liquid crystal polymer; polysulfone; polyethersulfone; polyetheretherketone; polyetherimide; polyamideimide; and polyimide.

The thickness of the substrate 1 is not particularly limited, but 5 μm or more provides an advantage of easily attaining a strength satisfactory as a carrier film, and 200 μm or less provides an advantage of easily forming, on approximately the same plane, the bottom face of the protruding portion 5 that is directed to the substrate 1 and the face opposite to the optical waveguide forming face of the substrate 1. Considering the above, the thickness of the substrate 1 is preferably in a range of 5 μm or more and 200 μm or less and more preferably in a range of 10 μm or more and 100 μm or less.

Lower Cladding Layer and Upper Cladding Layer

The lower cladding layer 2 and the upper cladding layer 4 are not particularly limited, as long as a resin that has a refractive index lower than the optical signal transmitting core pattern 31 and is curable by light and/or heat is used. A photo-sensitive resin, a thermosetting resin, and the like is preferably usable. Cladding layer forming resins that form the lower cladding layer 2 and the upper cladding layer 4 may contain the same or different ingredients. The refractive indexes thereof may be the same or different.

The lower cladding pattern 21 that is formed as the lower cladding layer 2 and the upper cladding pattern 41 that is formed as the upper cladding layer 4 may be patterned, for example, by lamination of a cladding layer forming resin layer followed by light exposure and development. In an alternate example of forming the lower cladding pattern 21 and the upper cladding pattern 41, they may be formed by applying, only on a desired portion, a film-like or varnish-like cladding layer forming resin. Considering positional alignment accuracy, photolithographic processing is preferable. In addition, the lower cladding pattern 21 may be formed on the entire face of the substrate 1 as: the lower cladding layer 2 is formed on the substrate 1, and then the layer is subjected to cutting processing such as laser processing, dicing, and the like.

Regarding the method of forming the lower cladding layer 2 and the upper cladding layer 4, there are not particular limitations on the method of laminating the cladding layer forming resin layer. For example, a cladding layer forming resin may be dissolved in a solvent and coated for lamination, or a cladding layer forming resin film that is preliminary prepared may be laminated.

The method of forming the lower cladding layer 2 and the upper cladding layer 4 is not limited when the method includes coating. The cladding layer forming resin may be coated in accordance with conventional processes.

Furthermore, when the method of forming the lower cladding layer 2 and the upper cladding layer 4 includes lamination, the cladding layer forming resin film that is use for lamination may be easily produced by dissolving the cladding layer forming resin in a solvent, coating on a supporting film, and then removing the solvent, for example.

The thickness of the lower cladding layer 2 (lower cladding pattern 21) and the upper cladding layer 4 (upper cladding pattern 41) is not particularly limited, but the thickness after each pattern is formed is preferably in a range of 5 μm or more and 500 μm or less. When the thickness after each pattern is formed is 5 μm or more, a cladding thickness required for light confinement is assured. When 500 μm or less, a low height optical waveguide may be attained. Considering the above, the thickness of the lower cladding pattern 21 and the upper cladding pattern 41 after each pattern is formed is more preferably in a range of 10 μm or more and 100 μm or less. In addition, the thickness of the lower cladding layer forming resin film and the upper cladding layer forming resin film, which are used for forming the lower cladding pattern 21 and the upper cladding pattern 41, is not particularly limited as long as the pattern having the aforementioned thickness is able to be formed, but from the viewpoint of easily attaining a resin film that has an uniform thickness, the thickness of the resin film is preferably 500 μm or less.

Optical Signal Transmitting Core Pattern

The optical signal transmitting core pattern 31 may be formed by lamination of a core layer forming resin layer, light exposure, and development, for example. As the core layer forming resin, preferably is used the one which has a higher refractive index than the lower cladding layer 2 (lower cladding pattern 21) and the upper cladding layer 4 (upper cladding pattern 41) and has a capability of providing a pattern by an action of active light. A method of forming the core layer forming resin layer before patterning is not limited. For example, the core layer forming resin may be dissolved in a solvent and coated for lamination, or a core layer forming resin film that is preliminary prepared may be laminated.

The thickness of the optical signal transmitting core pattern 31 is not particularly limited, but when the thickness of the optical signal transmitting core pattern 31 after it is formed is 10 μm or more, alignment tolerance in a coupling to a light receiving and emitting element or an optical fiber after the optical waveguide is formed may be advantageously enhanced. When 100 μm or less, coupling efficiency in a coupling to a light receiving and emitting element or an optical fiber after the optical waveguide is formed may be advantageously enhanced. Considering the above, the thickness of the optical signal transmitting core pattern 31 is preferably in a range of 10 μm or more and 100 μm or less and more preferably in a range of 30 μm or more and 90 μm or less. In order to obtain the aforementioned thickness, the thickness of the core layer forming resin film may be adjusted accordingly. However, from the viewpoint of easily obtaining a resin film having a uniform thickness, the thickness of the resin film may be preferably 500 μm or less.

It is preferable to use a core layer forming resin that is transparent to the light of optical signals used and has a capability of forming a pattern by an action of active light.

Protruding Pattern

The protruding pattern 32 may be formed, similarly to the aforementioned optical signal transmitting core pattern 31, by lamination of a core layer forming resin layer, light exposure, and development, for example. It is preferable to use the one that is capable of being patterned by an action of active light. A method of forming the core layer forming resin layer before it is patterned is not limited. For example, the core layer forming resin may be dissolved in a solvent and coated for lamination, or a core layer forming resin film that is preliminary prepared may be laminated.

The thickness of the protruding pattern 32 is not particularly limited, however, in the case of forming from the same core layer forming resin layer as the optical signal transmitting core pattern 31, the height from the optical waveguide forming face of the substrate 1 to the core upper face becomes almost the same as the height of the optical signal transmitting core pattern 31. The height of the protruding pattern 32 at the position where it is directly formed on the substrate 1 is given by the sum of the thicknesses of the lower cladding pattern and the optical signal transmitting core pattern, that is, (thickness of the lower cladding pattern)+(thickness of the optical signal transmitting core pattern). Furthermore, the thickness of the protruding pattern 32 at the position where the bottom face of the protruding pattern 32 is formed on approximately the same plane of the rear side of the optical waveguide forming face 13 is given by the sum of the thicknesses of the substrate, the lower cladding pattern, and the optical signal transmitting core pattern, that is, (thickness of the substrate)+(thickness of the lower cladding pattern)+(thickness of optical signal transmitting core pattern). When the substrate 1 or the substrate 1 and the lower cladding layer 2 that are under the protruding pattern 32 is removed, in the case of partially removing a part of the protruding pattern 32, the thickness of the protruding pattern 32 at the outer peripheral wall 33 becomes smaller than the aforementioned value.

The shape of the protruding pattern 32 viewed from the normal direction of the substrate 1 may only have a portion protruding out of the substrate outer periphery 11. The outer peripheral wall 33 thereof may be in a form of straight line, circular, circular wavy, or rectangular wavy. In the case of straight line, face alignment is available when a connector is positioned. In the case of circular, circular wavy, or triangular wavy, point fixing is available. Considering stability in positioning to the connector, face fixing is preferable. Considering insertability to the connector, point fixing is preferable.

The outer peripheral wall (side face) 33 of the protruding pattern 32 is preferably approximately perpendicular to the optical waveguide forming face 13 of the substrate 1 and may be curved or inclined within a range not to affect fitting to the connector. The angle between the outer peripheral wall 33 and the optical waveguide forming face 13 is preferably 75° or more and 105° or less (in a range approximately perpendicular), more preferably 85° or more and 95° or less, and still more preferably 87° or more and 93° or less. When the angle between the outer peripheral wall 33 and the optical waveguide forming face 13 is not 90°, there may not have any inconvenience as long as such an effect is not brought about that the most protruding portion out of the substrate 1 disables fitting to the connector.

The protruding pattern 32 holds the substrate outer periphery 11. Owing to this, the outer shape line of an optical waveguide product may be served as the outer peripheral wall 33 of the protruding pattern 32.

Furthermore, in the case of no adhesion between the protruding pattern 32 and the substrate 1 or weak adhesion, the protruding pattern 32 is formed preferably in a manner that the end part of the lower cladding pattern 22 and the end part of upper cladding pattern 42 are held.

Note that, the portion where the protruding pattern 32 is formed may be all or part of the substrate outer periphery of the substrate 1. In the case of forming on a part of the substrate outer periphery of the substrate 1, the protruding pattern 32 may be formed, within the outer shape of the product, at least on a portion that is used for positioning to a connector. At that time, the portions other than the protruding pattern 32 may be subjected to, after the protruding pattern 32 is formed, cutting processing with a dicing saw, laser abrasion, or outer shape-processing with a blade die or a metal die.

Protruding Portion

In the optical waveguide according to the first embodiment, the optical waveguide forming layer that is formed in a manner that it protrudes out of the substrate outer periphery 11 is called as a protruding portion 5. At least part of the protruding pattern 32 is formed to serve as the protruding portion 5. The protruding portion 5 is preferably the protruding pattern 32.

The bottom face of the protruding pattern 32 that serves as the protruding portion 5 is, as shown in FIG. 1, preferably formed in approximately the same plane of the rear side of the optical waveguide forming face 13 of the substrate 1. Whereby, no portion is protruded out of the rear side of the substrate 1 and no portion is caught when the optical waveguide and the connector are fitted to each other. In this way, fitting is performed advantageously.

Note that, the protruding portion 5 may be formed on all or part of the substrate outer periphery of the substrate 1. In the case of forming on a part of the substrate outer periphery of the substrate 1, within the outer shape of the product, at least a portion that is used for positioning to a connector may be served as the protruding portion 5. On this occasion, the portions other than the protruding portion 5 may be subjected to, after the protruding pattern 32 is formed, cutting processing with a dicing saw, laser abrasion, or outer shape-processing with a blade die or a metal die, for example.

The length (protruding amount in a parallel direction to the substrate 1) of the protruding portion 5 that protrudes out of the substrate 1 after processing may be in a range where the protruding pattern 32 is not broken when fitted to the connector 9, that is, from 0.1 μm or more to 100 μm or less. Considering processing accuracy and still more suppression of breakage of the protruding pattern 32, from 0.5 μm or more to 75 μm or less is more preferable and from 1 μm or more to 50 μm or less is still more preferable.

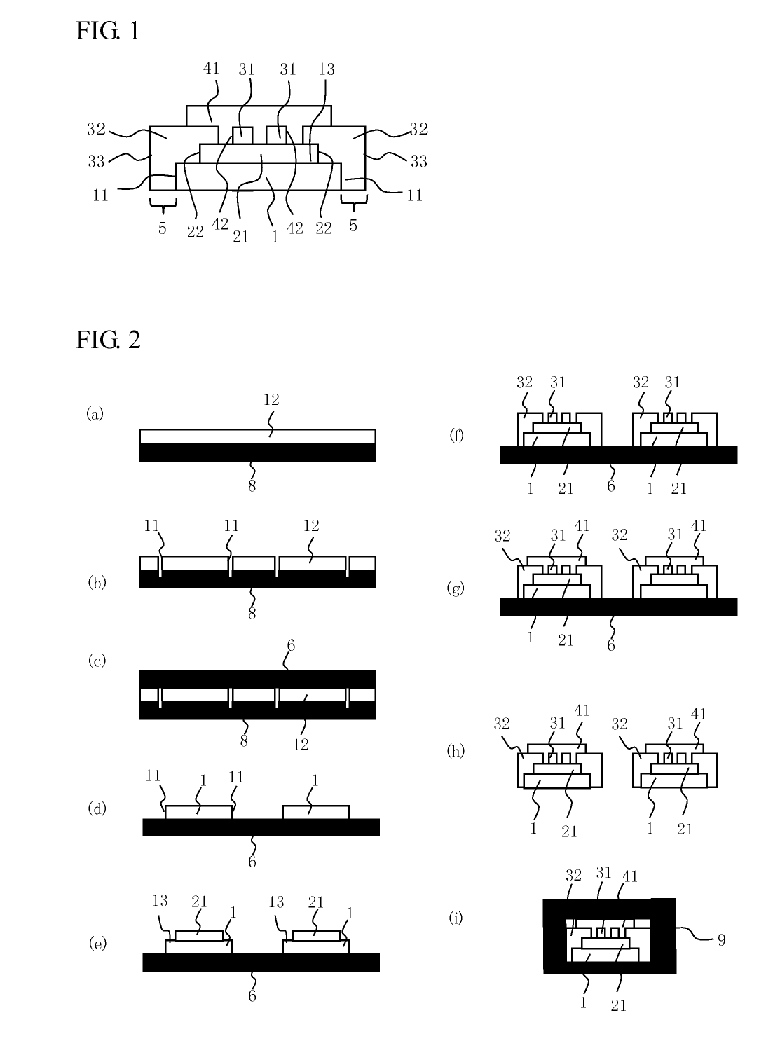

A manufacturing method of the optical waveguide according to the first embodiment of the present invention is described below by using FIG. 2.

Step A1

In the step A1, a method of forming the substrate 1 on a part of the supporting substrate 6 is not particularly limited. For example, one or more substrate 1 may be stuck on the supporting substrate 6, or a substrate sheet 12 that is used to form the substrate 1 on the supporting substrate 6 is stuck and then the substrate 1 may be formed by shape-processing. As a preferable method, there may be mentioned a method that is described later in “Step of preparing substrate 1”.

In addition, preferably, the supporting substrate 6 and the substrate 1 are in such a combination that they are fixed in the course of the processes in the manufacturing method of an optical waveguides, and the supporting substrate 6 is removed from the substrate 1 in a later step.

Step of Preparing Substrate 1

Firstly, the sheet-form substrate sheet 12 that serves as the substrate 1 after shape-processing is prepared. As shown in FIG. 2(a), the substrate sheet 12 is stuck on a temporary fixing sheet 8.

Next, as shown in FIG. 2(b), the substrate sheet 12 is subjected to shape-processing without cutting out the temporary fixing sheet 8. The method for the shape-processing is not particularly limited as long as the method is the one in which only the substrate sheet 12 is cut out. Examples of the method include: cutting processing with a dicing saw; laser abrasion processing; and processing with a blade die.

After that, as shown in FIG. 2(c), the supporting substrate 6 is laminated on the surface of the substrate sheet 12, wherein the surface is on the opposite side of the temporary fixing sheet 8.

Finally, as shown in FIG. 2(d), the temporary fixing sheet 8 is removed, so that a substrate having the substrate 1 that is disposed on the supporting substrate 6 is attained.

The aforementioned method has such an advantage that a plurality of the substrate 1 are allowed to be disposed on the supporting substrate 6 while pitch is unchanged, for example. Furthermore, engraved grooves are afraid of forming on the surface of the supporting substrate 6 when the substrate 1 is processed by dicing saws, laser abrasion, or the like after the substrate sheet 12 is stuck on the supporting substrate 6, and the protruding pattern 32 protrudes out of the bottom face of the substrate 1 in an amount of engraved groove depth. However, while no engraved groove is formed, the substrate 1 is advantageously formed on the supporting substrate 6 by transferring the substrate 1 from the temporary fixing sheet 8 to the supporting substrate 6. In addition, when the substrate 1 is transferred from the temporary fixing sheet 8 to the supporting substrate 6, the unnecessary remaining (cutting margin) of the substrate sheet 12 other than the substrate 1 is advantageously easily removed.

Note that, when only a part of the substrate outer periphery of the substrate 1 serves as the protruding portion 5, at least the portion that forms the protruding portion 5 may be subjected to shape-processing. The cutting margin and the substrate 1 may be partly connected.

Supporting Substrate

The supporting substrate 6 that supports the substrate 1 is not particularly limited as long as it is a substrate removable from the substrate 1. Considering removal performance, preferable examples thereof include: a metal substrate; each substrate that is listed for the substrate 1, a substrate that is given by forming a peeling layer on the forgoing substrate; and a resin substrate with metal foil (the resin substrate part thereof may be served as the substrate 1 and the substrate sheet 12). The thickness of the supporting substrate 6 is preferably from 5 μm to 20 mm. In 5 μm or more, the substrate 1 is able to be supported. In 20 mm or less, good handleability is assured. The thickness of the supporting substrate 6 is more preferably from 10 μm to 2 mm, because handleability becomes excellent.

Temporary Fixing Sheet

The kind of the temporary fixing sheet 8 that is laminated on the substrate sheet 12 is not particularly limited as long as it is capable of being delaminated from the substrate sheet 12 (substrate 1). Preferable examples thereof include: a metal substrate; each substrate that is listed for the substrate 1; a substrate that is given by forming a peeling layer on the foregoing each substrate; and a resin substrate with metal foil (the resin substrate part may be served as the substrate 1 or the substrate sheet 12).

Step B1

As shown in FIG. 2(e), the step B1 is described below, in which the lower cladding pattern 21 (lower cladding layer 2) is formed on the optical waveguide forming face 13 of the substrate 1.

The method of forming the lower cladding pattern 21 is not particularly limited. However, examples of the method of forming the lower cladding pattern 21 include: a method of coating a lower cladding layer forming resin composition partly on the substrate 1; a method of laminating partly on the substrate 1 a lower cladding layer forming resin film that is preliminary formed into a film by coating; and a method in which the lower cladding layer forming resin composition is coated or the lower cladding layer forming resin film that is preliminary formed into a film by coating is laminated and patterned by using photolithographic processing or the like. When photolithographic processing is performed, the lower cladding layer forming resin composition may be a photo-sensitive resin composition.

In an alternative method, a lower cladding layer is formed on the entire face of the substrate sheet 12, and then the substrate sheet 12 is subjected to shape-processing to the substrate 1 and, at the same time, the lower cladding layer 2 is processed into a lower cladding pattern 21 that has the same shape with the substrate 1. In the method in which the lower cladding layer 2 is processed into the lower cladding pattern 21 at the same time with the shape-processing of the substrate 1, when the method described in the aforementioned “Step of preparing substrate 1” is used, the following steps may be performed in order: forming the lower cladding layer 2 on the substrate sheet 12; further forming the temporary fixing sheet 8 on the lower cladding layer 2; after that, performing the shape-processing of the substrate 1 and the lower cladding pattern 21; forming the supporting substrate 6; and removing the temporary fixing sheet 8. In the case of performing the shape-processing of the substrate 1 and the lower cladding pattern 21 at the same time, the lower cladding layer forming resin composition may be a photo-sensitive resin composition or a thermosetting resin composition.

Step C1

As shown in FIG. 2(f), in the step C1 of forming the protruding pattern 32, the pattern may be formed through patterning using photolithographic processing. On this occasion, the protruding pattern 32 is formed on the supporting substrate 6, the substrate 1, and the lower cladding pattern 21 in a manner that the substrate outer periphery 11 is held, so that the outer shape line of the resulting product is allowed to serve as the outer peripheral wall 33 of the protruding pattern 32. By means of allowing the outer shape line of the resulting product to serve as the outer peripheral wall 33 of the protruding pattern 32, an optical waveguide having a high accuracy in the optical signal transmitting core pattern 31 and the outer peripheral wall 33 may be attained.

When the protruding pattern 32 is formed by photolithographic processing, the optical signal transmitting core pattern 31 and the protruding pattern 32 are formed simultaneously by using a single light-shielding mask, whereby positional displacement between the optical signal transmitting pattern 31 and the outer peripheral wall 33 that is used for positioning is suppressed, and good accuracy in mutual positional relation is attained, preferably.

Step D1

After the step C1, as shown in FIG. 2(g), the step D1 is preferably performed, in which the upper cladding pattern 41 (upper cladding layer 4) is formed at a position where the optical signal transmitting core pattern 31 is embedded and the end part of upper cladding pattern 42 is held by the protruding pattern 32.

By means of forming the upper cladding pattern 41 in a manner that it covers the upper face and side face of the optical signal transmitting core pattern 31, the optical signal transmitting core pattern 31 may be protected. In addition, by means of disposing the end part of upper cladding pattern 42 at a position where it is held by the protruding pattern 32, the protruding pattern 32 is partly held between the upper cladding pattern 41 and the substrate 1 (or the substrate 1 and the lower cladding pattern 21), whereby delamination or breakage of the protruding pattern 32 may be prevented in the following steps (step E1 and/or step F) or when the optical waveguide is fitted to a connector.

The method of forming the upper cladding pattern 41 is not particularly limited, but examples of the method of forming the upper cladding pattern 41 include: a method of coating partly an upper cladding layer forming resin composition on a desired part (on a part of the lower cladding pattern 21, the optical signal transmitting core pattern 31, or the protruding pattern 32); a method of laminating, partly on a desired part, an upper cladding layer forming resin film that is preliminary coated into a film; and a method of patterning by using photolithographic processing or the like, after, on the entire face of the supporting substrate 6, an upper cladding layer forming resin composition is coated or an upper cladding layer forming resin film that is preliminary coated into a film is laminated. When the upper cladding pattern 41 is partly coated or laminated, the upper cladding layer forming resin composition may be a thermosetting resin composition or a photo-sensitive resin composition. In the case of photographic processing, it may be a photo-sensitive resin composition. Considering accuracy in positioning when the upper cladding pattern is formed, it may be formed more preferably by photolithographic processing.

Step E1

As shown in FIG. 2(h), the method of removing the supporting substrate 6 in the step E1 is not particularly limited as long as the supporting substrate 6 is removed from the protruding portion 5. For example, when the protruding portion 5 and the supporting substrate 6 are peelable from each other, the supporting substrate 6 may be delaminated physically. An alternative method includes a method of dissolving and removing the supporting substrate 6 with a solvent in which the substrate 1 and the protruding portion 5 are not dissolved. Specific examples of the method of dissolving and removing include a method of using metal (for example, Cu) as the material for the supporting substrate 6 and removing it by etching.

Optical Module

As shown in FIG. 2(i), an optical module according to the first embodiment may be provided by connecting the optical waveguide that is produced in the aforementioned manufacturing method of an optical waveguide to the connector 9 of a separate member such as an optical fiber.

According to the optical waveguide in accordance with the first embodiment of the present invention, the substrate 1 is held by the protruding pattern 32, so that the outer shape line of an optical waveguide product is allowed to serve as the outer peripheral wall 33 of the protruding pattern 32. A high accuracy positioning of the optical signal transmitting core pattern 31 by means of the outer peripheral wall 33 is realized, whereby an optical waveguide with a high accuracy may be attained. This makes it easy to fit optical axes between the optical signal transmitting core pattern 31 and a light receiving and emitting member, whereby an optical waveguide having an excellent optical signal transmission efficiency is attainable.

Furthermore, according to the optical waveguide in accordance with the first embodiment of the present invention, even in the case of no or weak adhesion between the protruding pattern 32 and the substrate 1, by forming the protruding pattern 32 in a manner that at least either of the end part of the lower cladding pattern 22 and the end part of upper cladding pattern 42 is held, an adhesion interface between the protruding pattern 32 and at least either of the lower cladding pattern 21 and the upper cladding pattern 41 is formed. Whereby, adhesion is assured.

### Second Embodiment

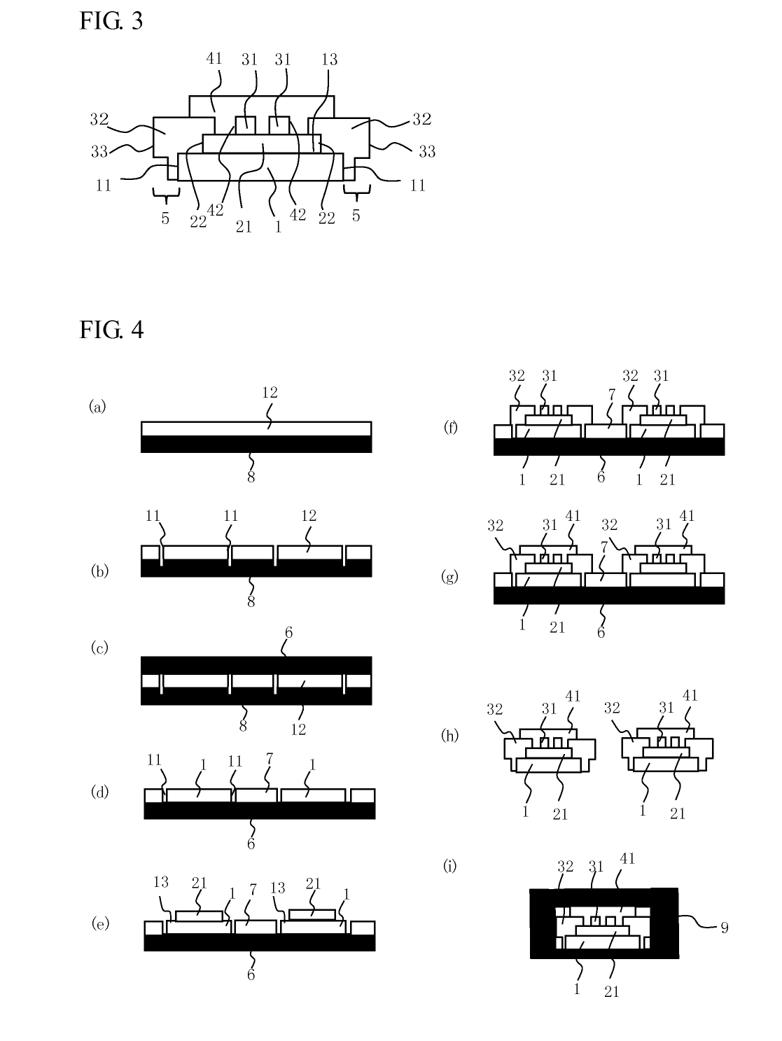

The optical waveguide in accordance with a second embodiment of the present invention, as shown in FIG. 3, as compared with the optical waveguide that is described in the first embodiment, is different in the point that the bottom face of the protruding pattern 32 that serves as the protruding portion 5 is formed, not on the rear side of the optical waveguide forming face 13, but on the side of the optical waveguide forming face 13. About the optical waveguide in accordance with the second embodiment, the parts that are described actually the same as the optical waveguide in accordance with the first embodiment are abbreviated so as to avoid duplicated description.

The manufacturing method of an optical waveguide in accordance with the second embodiment of the present invention is described by using FIG. 4, below.

Step A2

In the step A2, the method of forming the substrate 1 on a part of the supporting substrate 6 and forming a peeling substrate 7 nearby the substrate 1 is not particularly limited. For example, after the substrate 1 is stuck on the supporting substrate 6, the peeling substrate 7 may be further stuck nearby the substrate 1. When the protruding pattern 32 and the substrate 1 are peelable from each other, after the substrate sheet 12 that is used to form the substrate 1 on the supporting substrate 6 is stuck, the substrate 1 may be subjected to shape-processing so as to serve the substrate sheet 12 that is remained in the cutting margin as the peeling substrate 7.

As a preferable method of forming the substrate 1 that has the peeling substrate 7, there may be mentioned the method described later in “Step of preparing substrate 1”. The supporting substrate 6 and the substrate 1 are preferably such a combination that they are fixed in the process of forming the optical waveguide and that the supporting substrate 6 is allowed to be removed from the substrate 1 in a later step.

Step of Preparing Substrate 1

Firstly, as shown in FIG. 4(a), a sheet-form substrate sheet 12 that is processed into the substrate sheet 1 after shape-processing is prepared, and then the substrate sheet 12 is stuck on the temporary fixing sheet 8.

Next, as shown in FIG. 4(b), the substrate sheet 12 is subjected to shape-processing into the substrate 1 without cutting out the temporary fixing sheet 8. The method of the shape-processing is not particularly limited as long as only the substrate sheet 12 is cut out. Examples of the method may include: cutting processing using a deicing saw; laser abrasion processing; and processing with a blade die.

After that, as shown in FIG. 4(c), the supporting substrate 6 is laminated on the surface of the substrate sheet 12, on the opposite side to the temporary fixing sheet 8.

Finally, as shown in FIG. 4(d), by removing the temporary fixing sheet 8, a substrate having the substrate 1 and the peeling substrate 7 that are disposed on the supporting substrate 6 is attained.

By the aforementioned method, a plurality of the substrate 1 are advantageously disposed on the supporting substrate 6 while pitch is unchanged, for example. In addition, when the substrate 1 is processed by a dicing saw, laser abrasion, or the like after the substrate sheet 12 is stuck on the supporting substrate 6, engraved grooves are afraid of being formed on the surface of the supporting substrate 6, whereby the protruding pattern 32 protrudes out of the bottom face of the substrate 1 by an amount of engraved groove depth. However, by transferring the substrate 1 to the supporting substrate 6 from the temporary fixing sheet 8, the substrate 1 is advantageously formed on the supporting substrate 6 without forming the engraved grooves. Furthermore, when the substrate 1 is transferred from the temporary fixing sheet 8 to the supporting substrate 6, the unnecessary remaining (cutting margin) of the substrate sheet 12 other than the substrate 1 is intentionally remained, the step A2 (in the case of serving the substrate sheet 12 that is remained in the cutting margin as the peeling substrate 7) may be easily performed. When processing is allowed to be performed without forming the engraved grooves, or when any problem does not bring about even if the protruding pattern 32 protrudes out of the bottom face of the substrate 1 by an amount of engraved groove depth, the temporary fixing sheet 8 shown in FIG. 4(b) is regarded as the supporting substrate 6, and subsequent steps after the lower cladding pattern 21 may be performed.

Note that, when only a part of the substrate outer periphery of the substrate 1 is served as the protruding portion 5, in the substrate 1, at least the part which forms the protruding portion 5 may be subjected to shape-processing, and the cutting margin and the substrate 1 may be partly connected to each other.

Peeling Substrate

The peeling substrate 7 that is disposed on the same plane of the substrate 1 is not particularly limited as long as the substrate is removable from the supporting substrate 6. Considering removal performance, examples thereof may include preferably: a metal substrate; a substrate listed for the substrate 1; and a substrate that has a peeling layer thereon. The thickness of the peeling substrate 7 is preferably within ±30 μm of the thickness of the substrate 1, whereby the core pattern and the like may be formed almost without any height difference from the substrate 1.

Step B1

As shown in FIG. 4(e), the lower cladding pattern 21 (lower cladding layer 2) is formed on the optical waveguide forming face 13 of the substrate 1 (step B1).

Step C2

As shown in FIG. 4(f), in the step C2 of forming the protruding pattern 32, patterns may be formed by photolithographic processing. On this occasion, by forming the protruding pattern 32 on the supporting substrate 6, the substrate 1, and the lower cladding pattern 21 in a manner that the substrate outer periphery 11 is held, the outer shape line of the resulting product is allowed to be served as the outer peripheral wall 33 of the protruding pattern 32. By allowing the outer shape line of the resulting product to be served as the outer peripheral wall 33 of the protruding pattern 32, an optical waveguide having a high accuracy in the optical signal transmitting core pattern 31 and the outer peripheral wall 33 may be attained.

When the peeling substrate 7 and the substrate 1 are spaced from each other, by forming the protruding pattern 32 on the supporting substrate 6, the peeling substrate 7, the substrate 1, and the lower cladding pattern 21, the outer shape line of the resulting product is allowed to be served as the outer peripheral wall 33 of the protruding pattern 32. When the peeling substrate 7 and the substrate 1 are spaced from each other, also the protruding pattern 32 is partly formed on the supporting substrate 6. However, there is not any problem as long as the supporting substrate 6 and the protruding pattern 32 are peelable from each other.

When the protruding pattern 32 is formed by photolithographic processing, by forming the optical signal transmitting core pattern 31 and the protruding pattern 32 at the same time, positional displacement between the optical signal transmitting core pattern 31 and the outer peripheral wall 33 that is used for positioning is reduced, whereby good accuracy in positional relation therebetween is attained preferably.

Step D1

After the step C2, as shown in FIG. 4(g), the step D 1 is preferably performed, in which the upper cladding pattern 41 (upper cladding layer 4) is formed at the position where the optical signal transmitting core pattern 31 is embedded and the end part of upper cladding pattern 42 is held by the protruding pattern 32.

Step E1

As shown in FIG. 4(h), the supporting substrate 6 is removed (step E1).

Step F

As shown in FIG. 4(h), the method of removing the peeling substrate 7 in the step F is not particularly limited as long as the peeling substrate 7 is removed from the protruding portion 5. For example, when the protruding portion 5 and the peeling substrate 7 are peelable from each other, the peeling substrate 7 may be physically peeled off. Examples of an alternative method include a method of dissolving and removing the peeling substrate 7 with a solvent that hardly dissolves the substrate 1 and the protruding portion 5. As a specific method of dissolving and removing, there may be mentioned a method of using a metallic one (Cu or the like) as the peeling substrate 7 and removing it by etching.

Optical Module

As shown in FIG. 4(i), by fitting the optical waveguide that is manufactured by the aforementioned manufacturing method of an optical waveguide to the connector 9 that is a separate member such as an optical fiber connector, an optical module in accordance with the second embodiment may be attained.

The optical waveguide configured as above in accordance with the second embodiment of the present invention also provides the same effect as the optical waveguide in accordance with the first embodiment.

In addition, according to the manufacturing method of an optical waveguide in accordance with the second embodiment of the present invention, in the case of high adhesion between the supporting substrate 6 and the protruding pattern 32, when core patterning with thicker thickness is difficult, or when the protruding pattern 32 is not formed properly because the supporting substrate 6 scatters active light on light exposure, the step C2 is more preferable than the step C1 because the contact between the supporting substrate 6 and the protruding pattern 32 is limited by the peeling substrate 7.

### Third Embodiment

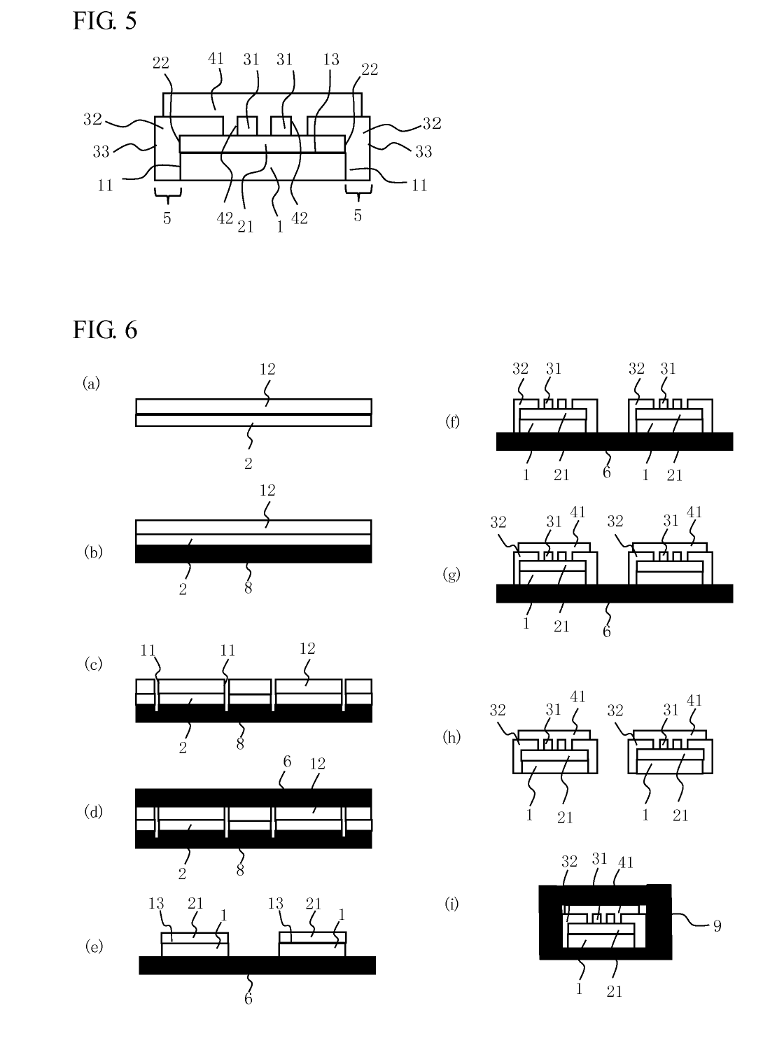

The optical waveguide in accordance with a third embodiment of the present invention, as shown in FIG. 5, as compared with the optical waveguide that is described in the first embodiment, is different in the point that the protruding portion 5 is the protruding pattern 32 and the upper cladding pattern 41. About the optical waveguide in accordance with the third embodiment, the parts that are described actually the same as the optical waveguide in accordance with the first embodiment are abbreviated so as to avoid duplicated description.

The manufacturing method of an optical waveguide in accordance with the third embodiment of the present invention is described by using FIG. 6, below.

Step A1 and Step B1

A step of forming the substrate 1 on a part of the supporting substrate 6 in the step A1 and a step of forming the lower cladding pattern 21 on the optical waveguide forming face 13 of the substrate 1 in the step B1 are performed at the same time.

Firstly, as shown in FIG. 6(a), the substrate sheet 12 and the lower cladding layer 2 are laminated. In a specific lamination method, the substrate sheet 12 that is prior to the shape-processing to the substrate 1 is stuck to a lower cladding layer forming resin film that is prior to the shape-processing to the lower cladding pattern 21.

Next, as shown in FIG. 6(b), the temporary fixing sheet 8 is laminated on the surface of the lower cladding layer 2.

Next, as shown in FIG. 6(c), the substrate sheet 12 and the lower cladding layer 2 are subjected to shape-processing into the substrate 1 and the lower cladding pattern 21, respectively, without cutting out the temporary fixing sheet 8. The method of shape-processing used here is not particularly limited as long as the method by which the substrate sheet 12 and the lower cladding layer 2 are able to be cut out. Examples of the method include: cutting processing with a dicing saw; laser abrasion processing; and processing with a blade die.

After that, as shown in FIG. 6(d), the supporting substrate 6 is laminated on the surface of the substrate sheet 12, on the opposite side to the temporary fixing sheet 8.

Then, as shown in FIG. 6(e), by removing the temporary fixing sheet 8, a substrate having the substrate 1 and the lower cladding pattern 21 that are laminated on the supporting substrate 6 is attained.

Step C1

As shown in FIG. 6(f), the protruding pattern 32 is formed (step C1).

Step D1

After the step C1, as shown in FIG. 6(g), the step D1 is preferably performed, in which the upper cladding pattern 41 (upper cladding layer 4) is formed at a position where the optical signal transmitting core pattern 31 is embedded and the end part of upper cladding pattern 42 is held by the protruding pattern 32.

Step E1

As shown in FIG. 6(h), the supporting substrate 6 is removed (step E1).

Optical Module

As shown in FIG. 6(i), by fitting the optical waveguide that is manufactured by the aforementioned manufacturing method of an optical waveguide to the connector 9 that is a separate member such as an optical fiber connector, an optical module in accordance with the third embodiment is attained.

The optical waveguide configured as above in accordance with the third embodiment of the present invention also provides the same effect as the optical waveguide in accordance with the first embodiment.

### Fourth Embodiment

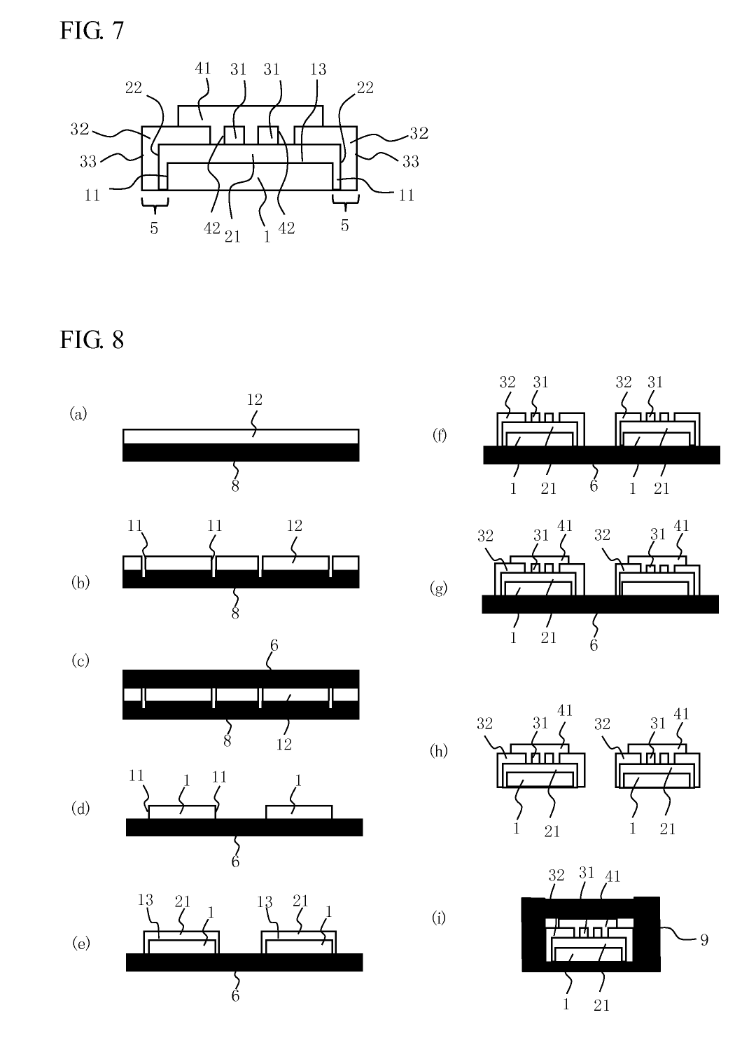

The optical waveguide in accordance with a forth embodiment of the present invention, as shown in FIG. 7, as compared with the optical waveguide that is described in the first embodiment, is different in the point that the protruding portion 5 is the protruding pattern 32 and the lower cladding pattern 21, and that the lower cladding pattern 21 is disposed in a manner that the lower cladding pattern 21 holds the substrate outer periphery 11 of the substrate 1. About the optical waveguide in accordance with the forth embodiment, the parts that are described actually the same as the optical waveguide in accordance with the first embodiment are abbreviated so as to avoid duplicated description.

The manufacturing method of an optical waveguide in accordance with the forth embodiment of the present invention is described, by using FIG. 8, below.

Step A1

In the step A1, the method of forming the substrate 1 on a part of the supporting substrate 6 is not particularly limited. For example, at least one of the substrate 1 may be stuck on the supporting substrate 6, or after the substrate sheet 12 that is used to form the substrate 1 is stuck on the supporting substrate 6, the substrate 1 may be subjected to shape-processing. As a preferable method, there may be mentioned a method that is described later in “Step of preparing substrate 1”.

In addition, preferably, the supporting substrate 6 and the substrate 1 are in such a combination that they are fixed in the course of the processes in the manufacturing method of optical waveguides and the supporting substrate 6 is removed from the substrate 1 in a later step.

Step of Preparing Substrate 1

Firstly, as shown in FIG. 8(a), a sheet-form substrate sheet 12, which serves as the substrate 1 after shape-processing, is prepared, and the substrate sheet 12 is stuck on a temporary fixing sheet 8.

Next, as shown in FIG. 8(b), the substrate sheet 12 is subjected to shape-processing into the substrate 1 without cutting out the temporary fixing sheet 8. The method for the shape-processing is not particularly limited as long as the method is the one in which only the substrate sheet 12 is cut out. Examples of the method include: cutting processing with a dicing saw; laser abrasion processing; and processing with a blade die.

After that, as shown in FIG. 8(c), the supporting substrate 6 is laminated on the surface of the substrate sheet 12, on the opposite side to the temporary fixing sheet 8.

Finally, as shown in FIG. 8(d), the temporary fixing sheet 8 is removed, so that a substrate with the substrate 1 disposed on the supporting substrate 6 is attained.

Step B1

As shown in FIG. 8(e), in the step B1 in which the lower cladding pattern 21 is formed in a manner that the substrate outer periphery 11 is held thereby, patterns may be formed by photolithographic processing.

Step C1

As shown in FIG. 8(f), the protruding pattern 32 is formed (step C1).

Step D1

After the step C1, as shown in FIG. 8(g), the step D1 is preferably performed, in which the upper cladding pattern 41 (upper cladding layer 4) is formed at the position where the optical signal transmitting core pattern 31 is embedded and the end part of upper cladding pattern 42 is held by the protruding pattern 32.

Step E1

As shown in FIG. 8(h), the supporting substrate 6 is removed (step E1).

Optical Module

As shown in FIG. 8(i), by fitting the optical waveguide that is manufactured by the aforementioned manufacturing method of an optical waveguide to the connector 9 that is a separate member such as an optical fiber connector, an optical module in accordance with the forth embodiment is attained.

The optical waveguide configured as above in accordance with the forth embodiment of the present invention also provides the same effect as the optical waveguide in accordance with the first embodiment.

### Fifth Embodiment

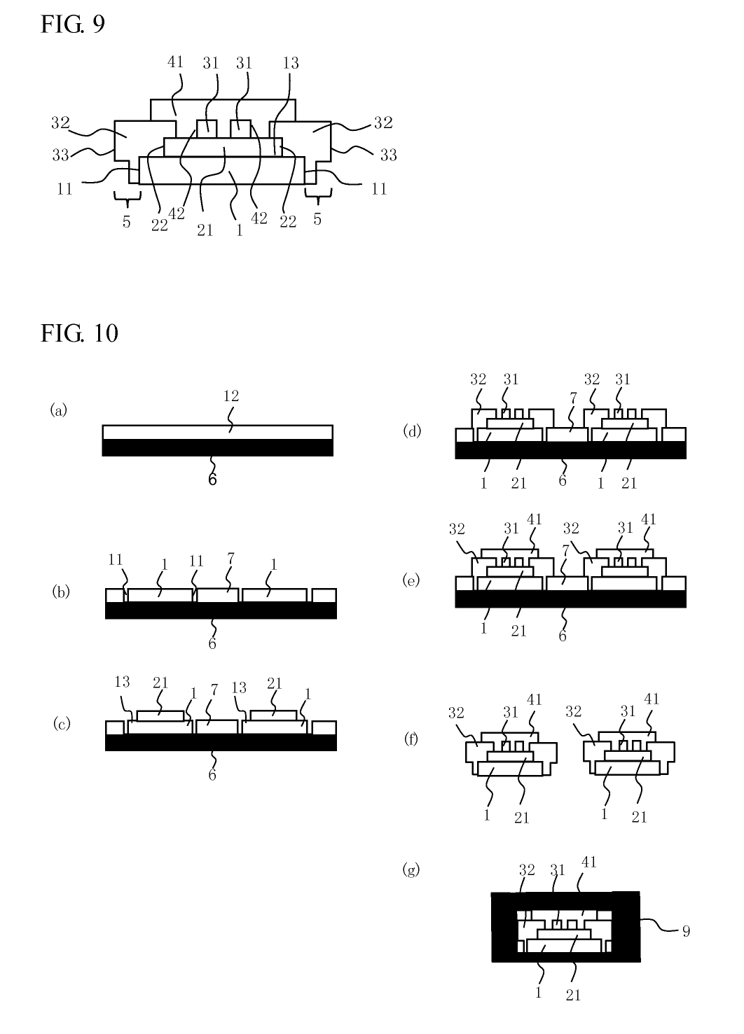

The optical waveguide in accordance with the fifth embodiment of the present invention is, as shown in FIG. 9, actually the same as the optical waveguide described in the second embodiment. About the optical waveguide in accordance with the fifth embodiment, the parts that are described actually the same as the optical waveguide in accordance with the second embodiment are abbreviated so as to avoid duplicated description.

The manufacturing method of an optical waveguide in accordance with the fifth embodiment of the present invention is described by using FIG. 10, below.

Step A2

In the step A2, the method of forming the substrate 1 on a part of the supporting substrate 6 and forming a peeling substrate 7 nearby the substrate 1 is not particularly limited. For example, after the substrate 1 is stuck on the supporting substrate 6, the peeling substrate 7 may be further stuck nearby the substrate 1. When the protruding pattern 32 and the substrate 1 are peelable from each other, after the substrate sheet 12 that is used to form the substrate 1 on the supporting substrate 6 is stuck, the substrate 1 may be subjected to shape-processing so as to serve the substrate sheet 12 that is remained in the cutting margin as the peeling substrate 7.

As a preferable method of forming the substrate 1 that has the peeling substrate 7, there may be mentioned the method described later in “Step of preparing substrate 1”. The supporting substrate 6 and the substrate 1 are preferably such a combination that they are fixed in the process of forming the optical waveguide and that the supporting substrate 6 is removable from the substrate 1 in a later step.

Step of Preparing Substrate 1

Firstly, as shown in FIG. 10(a), a sheet-form substrate sheet 12, which is processed into the substrate sheet 1 after shape-processing, is prepared, and then the substrate sheet 12 is stuck on the supporting substrate 6.

Next, as shown in FIG. 10(b), the substrate sheet 12 is subjected to shape-processing into the substrate 1 without forming concaves in the surface of the supporting substrate 6. The method of the shape-processing is not particularly limited as long as only the substrate sheet 12 is cut out. For example, there may be mentioned laser abrasion processing or the like.

In accordance with the aforementioned step, a substrate having the substrate 1 and the peeling substrate 7 that are disposed on the supporting substrate 6 is attained.

By the aforementioned method, a plurality of the substrate 1 are advantageously disposed on the supporting substrate 6 while pitch is unchanged, for example.

Note that, when only a part of the substrate outer periphery of the substrate 1 is served as the protruding portion 5, in the substrate 1, at least the part which forms the protruding portion 5 may be subjected to shape-processing, and the cutting margin and the substrate 1 may be partly connected to each other.

Peeling Substrate

The peeling substrate 7 that is disposed on the same plane of the substrate 1 is not particularly limited as long as the substrate is removable from the supporting substrate 6. Considering removal performance, examples thereof may include preferably: a metal substrate; a substrate listed for the substrate 1; and a substrate that has a peeling layer thereon. The thickness of the peeling substrate 7 is preferably within ±30 μm of the thickness of the substrate 1, whereby the core pattern and the like may be formed almost without any height difference from the substrate 1.

Step B1

As shown in FIG. 10(c), the lower cladding pattern 21 (lower cladding layer 2) is formed on the optical waveguide forming face 13 of the substrate 1 (step B1).

Step C2

As shown in FIG. 10(d), in the step C2 of forming the protruding pattern 32, patterns may be formed by photolithographic processing. On this occasion, by forming the protruding pattern 32 on the supporting substrate 6, the substrate 1, and the lower cladding pattern 21 in a manner that the substrate outer periphery 11 is held, the outer shape line of the resulting product is allowed to be served as the outer peripheral wall 33 of the protruding pattern 32. By allowing the outer shape line of the resulting product to be served as the outer peripheral wall 33 of the protruding pattern 32, an optical waveguide having a high accuracy in the optical signal transmitting core pattern 31 and the outer peripheral wall 33 may be attained.

When the peeling substrate 7 and the substrate 1 are spaced from each other, by forming the protruding pattern 32 on the supporting substrate 6, the peeling substrate 7, the substrate 1, and the lower cladding pattern 21, the outer shape line of the resulting product is allowed to be served as the outer peripheral wall 33 of the protruding pattern 32. When the peeling substrate 7 and the substrate 1 are spaced from each other, the protruding pattern 32 is partly formed also on the supporting substrate 6. However, there is not any problem as long as the supporting substrate 6 and the protruding pattern 32 are peelable from each other.

When the protruding pattern 32 is formed by photolithographic processing, by forming the optical signal transmitting core pattern 31 and the protruding pattern 32 at the same time with a single light-shielding mask, positional displacement between the optical signal transmitting core pattern 31 and the outer peripheral wall 33 that is used for positioning is reduced, whereby good accuracy in positional relation therebetween is attained preferably.

Step D1

After the step C2, as shown in FIG. 10(e), the step D1 is preferably performed, in which the upper cladding pattern 41 (upper cladding layer 4) is formed at the position where the optical signal transmitting core pattern 31 is embedded and the end part of upper cladding pattern 42 is held by the protruding pattern 32.

Step E1

As shown in FIG. 10(f), the supporting substrate 6 is removed (step E1).

Step F

As shown in FIG. 10(f), the method of removing the peeling substrate 7 in the step F is not particularly limited as long as the peeling substrate 7 is removed from the protruding portion 5. For example, when the protruding portion 5 and the peeling substrate 7 are peelable from each other, the peeling substrate 7 may be physically peeled off Examples of an alternative method include a method of dissolving and removing the peeling substrate 7 with a solvent that hardly dissolves the substrate 1 and the protruding portion 5. As a specific method of dissolving and removing, there may be mentioned a method of using a metallic one (Cu or the like) as the peeling substrate 7 and removing it by etching.

Optical Module

As shown in FIG. 10(g), by fitting the optical waveguide that is manufactured by the aforementioned manufacturing method of an optical waveguide to the connector 9 that is a separate member such as an optical fiber connector, an optical module in accordance with the fifth embodiment is attained.

The optical waveguide configured as above in accordance with the fifth embodiment of the present invention also provides the same effect as the optical waveguide in accordance with the first and second embodiments.

In addition, according to the manufacturing method of an optical waveguide in accordance with the fifth embodiment of the present invention, in the step of preparing the substrate 1, the substrate sheet 12 is subjected to shape-processing into the substrate 1 without forming concaves in the surface of the supporting substrate 6, so that the temporary fixing sheet 8 is not needed. Whereby, number of members used therein may be reduced and the manufacturing process may be simplified.

### Sixth Embodiment

### Optical Waveguide

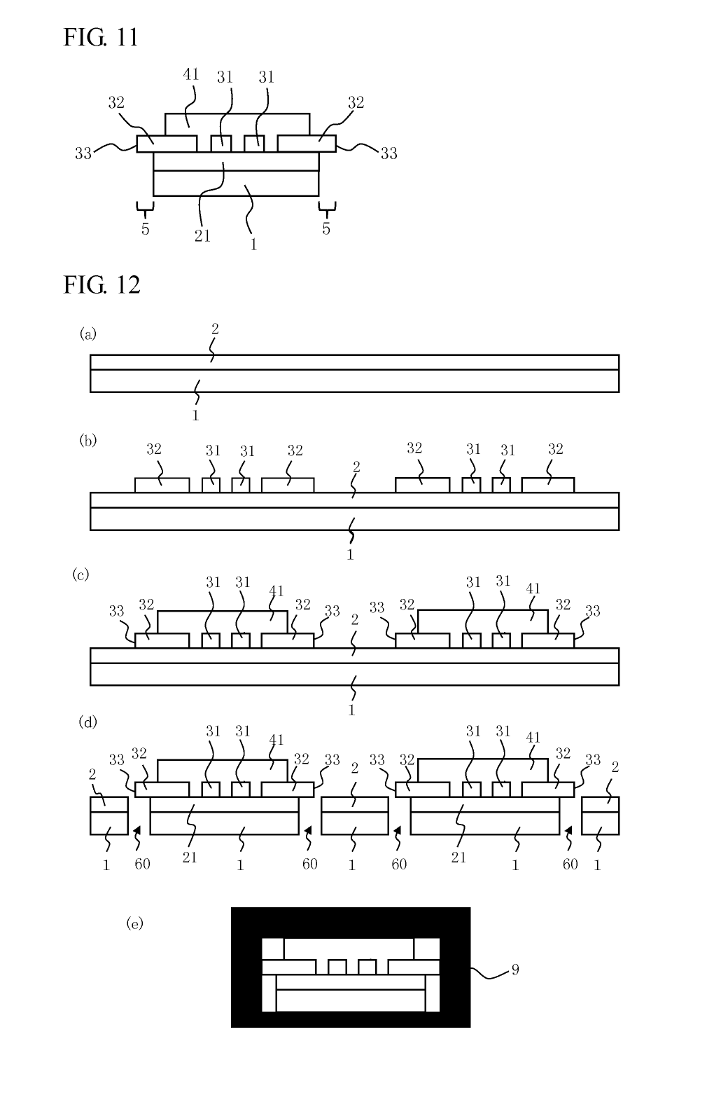

The optical waveguide in accordance with the sixth embodiment of the present invention is, as shown in FIG. 11, as compared with the optical waveguide that is described in the first embodiment, different in the point that the protruding portion 5 is only the protruding pattern 32. About the optical waveguide in accordance with the six embodiment, the parts that are described actually the same as the optical waveguide in accordance with the first embodiment are abbreviated so as to avoid duplicated description.

Manufacturing Method of Optical Waveguide

The manufacturing method of an optical waveguide in accordance with the six embodiment of the present invention includes the step B2, the step C3, the step D2, and the step E2.

The manufacturing method of an optical waveguide in accordance with the sixth embodiment of the present invention is described by using FIG. 12, below.

Step B2

As shown in FIG. 12(a), the lower cladding layer 2 is formed on the substrate 1 (step B2).

Step C3

After that, in the step C3, as shown in FIG. 12(b), on the lower cladding layer 2 that is formed on the substrate 1, the stretching optical signal transmitting core pattern 31 is formed. Further, the protruding patterns 32 are formed in a manner that the optical signal transmitting pattern 31 is positioned therebetween.

In the step C3, when the optical signal transmitting core pattern 31 and the protruding pattern 32 are processed and formed simultaneously, positional relation between them is kept better. Whereby, the positional relation between the outer peripheral wall 33 after the step C3 and the optical signal transmitting core pattern 31 becomes preferably better. Considering that the optical signal transmitting core pattern 31 and the protruding pattern 32 are allowed to be processed simultaneously, they are preferably formed by photolithographic processing.

Step D2

In the step D2, as shown in FIG. 12(c), the upper cladding pattern 41 is formed in a manner that the side face 33 of the protruding pattern 32, which does not face to the side face of the optical signal transmitting core pattern 31, exposes and embeds therein the optical signal transmitting core pattern 31. The upper cladding pattern 41, as shown in FIG. 12(c), preferably has such a structure that it is formed on the lower cladding layer 2 and the protruding pattern 32. However, it is important that the upper cladding pattern 41 is formed in a manner that the optical signal transmitting core pattern 31 is embedded therein. So that, a structure of being formed not on the protruding pattern 32 may be selectable.

In the step D2, considering that accuracy in positioning on the lower cladding layer 2 and the protruding pattern 32 is improved, the upper cladding pattern 41 is preferably formed by photolithographic processing. In addition, the upper cladding pattern 41 that is formed in a space between the optical signal transmitting core pattern 31 and the protruding pattern 32 and the upper cladding pattern 41 that is formed on the space and the protruding pattern 32 are preferably formed not separately but into one body, from the viewpoint of securing optical waveguide strength.

Step E2

In the step E2, as shown in FIG. 12(d), the substrate 1 and the lower cladding layer 2 (or the substrate 1) under the protruding pattern 32 are removed.

The method of removing is not particularly limited, but examples thereof include preferably cutting processing such as router processing, dicing processing and laser abrasion, and etching. From the viewpoint of controlling the depth of the removing portion, dicing processing is preferable. When cutting is performed by dicing processing, removing may be achieved by using an approximately rectangular dicing blade.

When cutting processing is performed from the side of the substrate 1, the protruding pattern 32 is easily preferably served as the outermost periphery (outer end part).

In the step E2, the substrate 1 and the lower cladding layer 2 under the protruding pattern 32 or the substrate 1 are removed preferably in a manner that the outer peripheral wall 33 becomes the outermost periphery of the optical waveguide. Specifically, as shown in FIG. 12(d), in order to serve the outer peripheral wall 33 as the outermost periphery of the optical waveguide, a portion (removing portion 60) that is to be removed and consists of the substrate 1 and the lower cladding layer 2 under the protruding pattern 32 are removed, whereby an optical waveguide having the outer peripheral wall 33 that serves as the outer end part is attained. At least a part of the outer peripheral wall 33 that consists of the protruding pattern 32 is remained, the outer peripheral wall 33 may be used for positioning when a connector or the like is fixed. Whereby, a high accuracy in positioning between the optical signal transmitting core pattern 31 and a light emitting and receiving member (light emitting and receiving element, optical fiber, or the like) may be assured.

In the case of removing the substrate 1 and the lower cladding layer 2 by cutting processing so as to obtain the shape shown in FIG. 12(d), the substrate 1 that exists outside of the outer peripheral wall 33 may be preferably cut out by cutting to such a depth as to reach the protruding pattern 32 on the side of the outer peripheral wall 33. The cutting depth of the protruding pattern 32 has not particularly any problem as long as the outer peripheral wall 33 of the protruding pattern 32 remains. The cutting amount (length perpendicular to the substrate) of the outer peripheral wall 33 is preferably 0.5 μm or more and 20 μm or less, more preferably 0.5 μm or more and 10 μm or less, and still more preferably 0.5 μm or more and 5 μm or less. By reducing the cutting amount of the outer peripheral wall 33 as small as possible, in the case of fitting to a connector 9 or the like, fixing is allowed in a wider area (outer peripheral wall 33).

In the step E2, by removing in a manner that at least a part of the substrate 1 and the lower cladding layer 2 under the protruding pattern 32 remains, breakage of the protruding pattern 32 is preferably prevented.

In addition, in the case of developing trails when the protruding pattern 32 is patterned by photolithographic processing, the trails cause interference when the optical waveguide is fitted to a connector or the like, so that the trails are preferably removed in the present step.

Optical Module

As shown in FIG. 12(e), by fitting the optical waveguide that is manufactured by the aforementioned manufacturing method of an optical waveguide to the connector 9 that is a separate member such as an optical fiber connector, an optical module may be attained, On this occasion, by fitting in a manner that the outer peripheral wall 33 of the protruding pattern 32 of the optical waveguide contacts to the inside wall face of the connector 9, positioning between the optical waveguide and the connector 9 may be performed easily with high accuracy.

The optical waveguide configured as above in accordance with the sixth embodiment of the present invention also provides the same effect as the optical waveguide in accordance with the first embodiments.

### Seventh Embodiment

### Optical Waveguide

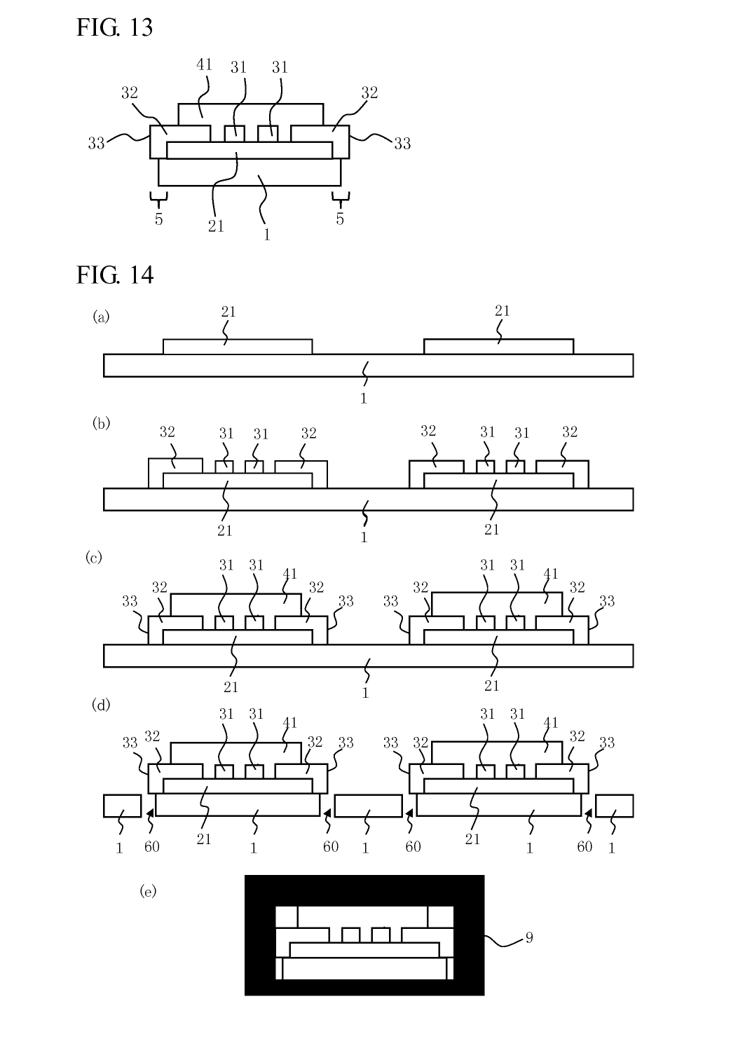

The optical waveguide in accordance with the seventh embodiment of the present invention is, as shown in FIG. 13, as compared with the optical waveguide that is described in the sixth embodiment, different in the point that the protruding pattern 32 is disposed in a manner that the end part of the patterned lower cladding layer 2 (lower cladding pattern 21) is held thereby and that the bottom face of the protruding pattern 32 is formed on the optical waveguide forming face of the substrate 1. The seventh embodiment of the present invention is described below, but the parts that are described actually the same as the optical waveguide in accordance with the sixth embodiment are abbreviated so as to avoid duplicated description.

The thickness of the protruding pattern 32 at the position where it is disposed directly on the substrate 1 is roughly the sum of the thicknesses of the substrate, the lower cladding layer, and the optical signal transmitting core pattern, namely, (thickness of the substrate)+(thickness of the lower cladding layer)+(thickness of the optical signal transmitting core pattern). In the step E3, in the case of partly removing a part of the protruding pattern 32 when the substrate 1 under the protruding pattern 32 is removed, the thickness of the protruding pattern 32 at the position of the outer peripheral wall 33 becomes smaller than the aforementioned value.

Manufacturing Method of Optical Waveguide

The manufacturing method of an optical waveguide in accordance with the seventh embodiment of the present invention includes the step B1, the step C4, the step D2, and the step E3.

The manufacturing method of an optical waveguide in accordance with the seventh embodiment of the present invention is described by using FIG. 14, below.

Step B1

As shown in FIG. 14(a), the lower cladding pattern 21 (lower cladding layer 2) is formed on the optical waveguide forming face 13 of the substrate 1 (step B1).

Step C4

Then, as shown in FIG. 14(b), the optical signal transmitting core pattern 31 is formed on the lower cladding layer 2, and, on the substrate 1 and/or the lower cladding layer 2, the protruding pattern 32 is formed in a manner that the optical signal transmitting core pattern 31 is disposed therebetween.

As shown in FIG. 14(b), a structure of forming the protruding pattern 32 on the substrate 1 and the lower cladding pattern 21 (or on the lower cladding pattern 21) is preferable. However, because the lower cladding pattern 21 is formed into a pattern, a structure of forming the protruding pattern 32, not on the lower cladding pattern 21, but on the substrate 1 that is on the outside thereof, may be selectable.

The protruding pattern 32 is preferably formed on the substrate 1, whereby the thickness of the outer peripheral wall 33 is assured and stable fitting to a connector or the like is allowed to be performed, as compared with the case of forming only on the lower cladding layer 2. Furthermore, in the case of weak adhesion between the protruding pattern 32 and the substrate 1, when the protruding pattern 32 is formed in a manner that the end part of the patterned lower cladding layer 2 is held, interfacial adhesion between the lower cladding layer 2 and the protruding pattern 32 is preferably assured.

Step D2

In the step D2, as shown in FIG. 14(c), the upper cladding pattern 41 is formed in a manner that the side face 33 of the protruding pattern 32, which does not face to the side face of the optical signal transmitting core pattern 31, exposes and embeds therein the optical signal transmitting core pattern 31. The upper cladding pattern 41, as shown in FIG. 14(c), preferably has such a structure that it is formed on the lower cladding pattern 21 and the protruding pattern 32. However, it is important that the upper cladding pattern 41 is formed in a manner that the optical signal transmitting core pattern 31 is embedded therein. So that, a structure of being formed not on the protruding pattern 32 may be selectable.

Step E3 In the step E3, as shown in FIG. 14(d), the substrate 1 (or the substrate 1 and the lower cladding pattern 21) under the protruding pattern 32 is removed. Note that, details of the step E3 are actually the same as the ones of the step E2 that are described in the aforementioned sixth embodiment.

Optical Module

As shown in FIG. 14(e), by fitting the optical waveguide that is manufactured by the aforementioned manufacturing method of an optical waveguide to the connector 9 that is a separate member such as an optical fiber connector, an optical module may be attained, On this occasion, by fitting in a manner that the outer peripheral wall 33 of the protruding pattern 32 of the optical waveguide contacts to the inside wall face of the connector 9, positioning between the optical waveguide and the connector 9 may be performed easily with high accuracy.

The optical waveguide configured as above in accordance with the seventh embodiment of the present invention also provides the same effect as the optical waveguide in accordance with the sixth embodiment.

In addition, according to the optical waveguide in accordance with the seventh embodiment, the protruding pattern 32 is formed at the position where the lower cladding pattern 21 is patterned and the lower cladding layer 2 is removed, so that the thickness of the protruding pattern 32 becomes thicker than the thickness of the optical signal transmitting core pattern 31. Therefore, the strength of the protruding pattern 32 is enhanced and cracking and chipping of the protruding pattern 32 may be reduced.

### Eighth Embodiment

### Optical Waveguide

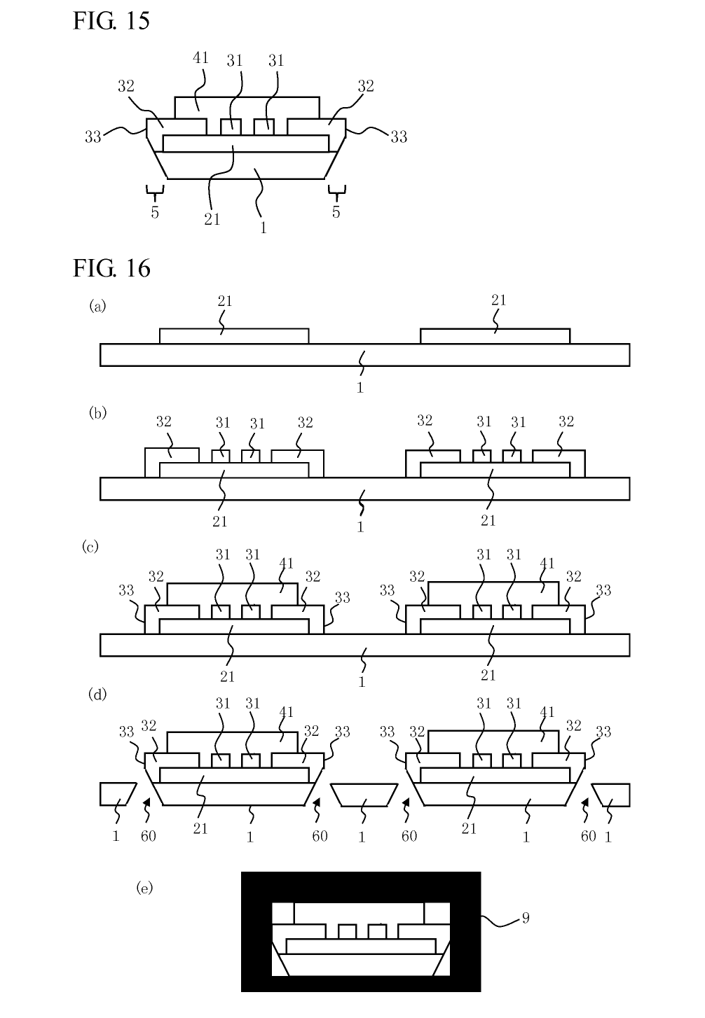

The optical waveguide in accordance with the eighth embodiment of the present invention is, as shown in FIG. 15, as compared with the optical waveguide described in the seventh embodiment, different in the point that the protruding pattern 32 is disposed in a manner that the end part of the patterned lower cladding layer 2 (lower cladding pattern 21) is held thereby and that the outer peripheral wall 33 of the protruding pattern 32 is a series of inclined faces. The eighth embodiment of the present invention is described in detail below, but the parts that are actually the same as the parts described in the seventh embodiment are abbreviated so as to avoid duplicated description.

Manufacturing Method of Optical Waveguide

The manufacturing method of an optical waveguide in accordance with the eighth embodiment of the present invention includes the step B1, the step C4, the step D2, and the step E3.

The manufacturing method of an optical waveguide in accordance with the eighth embodiment of the present invention is described by using FIG. 16, below.

Step B1

As shown in FIG. 16(a), the lower cladding pattern 21 (lower cladding layer 2) is formed on the optical waveguide forming face 13 of the substrate 1 (step B1).

In the manufacturing method of an optical waveguide in accordance with the eighth embodiment, the step B 1 and the step B2 may be appropriately selected, but the case of performing the step B1 is described herein as an example.

Step C4

Then, as shown in FIG. 16(b), the optical signal transmitting core pattern 31 is formed on the lower cladding layer 2, and, on the substrate 1 and/or the lower cladding layer 2, the protruding pattern 32 is formed in a manner that the optical signal transmitting core pattern 31 is disposed therebetween.

Step D2

In the step D2, as shown in FIG. 16(c), the upper cladding pattern 41 is formed in a manner that the side face 33 of the protruding pattern 32, which does not face to the side face of the optical signal transmitting core pattern 31, exposes and embeds therein the optical signal transmitting core pattern 31.

Step E3

In the step E3, as shown in FIG. 16(d), the substrate 1 (or the substrate 1 and the lower cladding pattern 21) under the protruding pattern 32 is removed.

In the step E3, at least a part of the substrate 1 and the protruding pattern 32 is removed in a manner that the cross section becomes an approximately triangular shape. In the case of cutting into the approximately triangular shape (cross sectional view) shown in FIG. 16(d) by dicing processing, there may be removed by using a dicing blade having an inclined face.

In the step E3, in the case of removing in a manner that at least a part of the substrate 1 and the protruding pattern 32 has an inclined face, the angle between the surface f the substrate 1 and the inclined face is not particularly limited, but preferably 30° or more and 89° or less, more preferably 40° or more and 80° or less, and still more preferably 45° or more and 75° or less. At a degree of 40° or more, the cutting amount of the substrate 1 and/or the lower cladding pattern 21 is so small that the strength of the optical waveguide may be secured.

Optical Module

As shown in FIG. 16(e), by fitting the optical waveguide that is manufactured by the aforementioned manufacturing method of an optical waveguide to the connector 9 that is a separate member such as an optical fiber connector, an optical module may be attained, On this occasion, by fitting in a manner that the outer peripheral wall 33 of the protruding pattern 32 of the optical waveguide contacts to the inside wall face of the connector 9, positioning between the optical waveguide and the connector 9 may be performed easily with high accuracy.

The optical waveguide configured as above in accordance with the eighth embodiment of the present invention also provides the same effect as the optical waveguide in accordance with the sixth embodiment.

In addition, the optical waveguide in accordance with the eighth embodiment has an inclined face from the substrate 1 to the outer peripheral wall 33 of the protruding pattern 32, so that catches are reduced in the protruding pattern 32. Whereby cracking and chipping of the protruding pattern 32 may be reduced.

### EXAMPLES

Hereinafter, the present invention will be further described in detail with reference to the following examples, but it should be construed that the invention is in no way limited to those examples within the scope of the invention.

### Example 1

### Preparation of Cladding Layer Forming Resin Film

### Preparation of (Meth) Acrylic Polymer (A) (Base Polymer)

To a flask equipped with an agitator, a condenser tube, a gas inlet tube, a dropping funnel, and a thermometer, 46 parts by mass of propylene glycol monomethylether acetate and 23 parts by mass of methyl lactate were weighed and transferred, which were agitated while nitrogen gas was introduced. The liquid temperature was elevated to 65° C., a mixture of 47 parts by mass of methyl methacrylate, 33 parts by mass of butyl acrylate, 16 parts by mass of 2-hydroxyethyl methacrylate, 14 parts by mass of methacrylic acid, 3 parts by mass of 2,2′-azobis (2, 4-dimethyl valeronitrile), 46 parts by mass of propylene glycol monomethylether acetate, and 23 parts by mass of methyl lactate was dropped over 3 hours. After that, agitation was performed at 65° C. for 3 hours. Further, agitation was continued at 95° C. for 1 hour, so that a solution of a (meth) acrylic polymer (A) (45 mass % of solid content) was obtained.

Measurement of Weight Average Molecular Weight

The weight average molecular weight (in terms of standard polystyrene) of the (meth) acrylic polymer (A) was measured to be 3.9×10⁴, by using GPC (“SD-8022”, “DP-8020”, and “RI-8020”, manufactured by TOSOH Corp.). Note that, columns of “Gelpack GL-A150-S” and “Gelpack GL-A160-S”, manufactured by Hitachi Chemical Corp. were used.

### Measurement of Acid Value

The acid value of the (meth) acrylic polymer (A) was measured to be 79 mgKOH/g. Note that, the acid value was calculated from the amount of 0.1 mol/L potassium hydroxide aqueous solution that was required to neutralize the solution of the (meth) acrylic polymer (A). At this time, a point at which phenolphthalein that was added as an indicator changed from colorless to pink color was selected to be the neutralization point.

### Preparation of Cladding Layer Forming Resin Varnish

As a base polymer, 84 parts by mass (38 parts by mass of solid content) of a solution of the (meth) acrylic polymer (A) (45 mass % of solid content); (B) as a photo-curing ingredient, 33 parts by mass of an urethane (meth) acrylate having polyester framework (“U-200AX”, manufactured by Shin-Nakamura Chemical Co., Ltd.) and 15 parts by mass of an urethane (meth) acrylate having polypropylene glycol framework (“UA-4200”, manufactured by Shin-Nakamura Chemical Co., Ltd.); (C) as a thermosetting ingredient, 20 parts by mass of a solution (75 mass % of solid content) of a multi-functional blocked isocyanate in which an isocyanurate trimer of hexamethylene diisocyanate was protected with methylethylketone oxime (“SUMIDUR BL3175”, manufactured by Sumika Bayer Urethane Co., Ltd.); (D) as a photo-polymerization initiator, 1 part by mass of 1-[4-(2-hydroxyethoxy) phenyl]-2-hydroxy-2-methyl-1-propane-1-on (“IRGACURE 2959”, manufactured by BASF Japan Ltd.) and 1 part by mass of bis(2, 4, 6-trimethylbenzoyl) phenylphosphine oxide (“IRGACURE 819”, manufactured by BASF Japan Ltd.); and as an organic diluent solvent, 23 parts by mass of propylene glycol monomethylether acetate were mixed while agitated. After pressure filtration with a “POLYFLON” filter having a pore size of 2 μm (“PF020”, manufactured by Advantec Toyo Kaisha, Ltd.), vacuum degassing was performed so as to obtain a cladding layer forming resin varnish.

### Preparation of Cladding Layer Forming Resin Film

The cladding layer forming resin varnish obtained above was coated on a PET film (“COSMOSHINE A4100”, manufactured by Toyobo Co., Ltd., 50 μm thick) serving as a supporting film with a coating machine (multi-coater “TM-MC”, manufactured by HIRANO TECSEED Co., Ltd.) and dried at 100° C. for 20 minutes. Then, a PET film having surface release treatment (“PUREX A31”, manufactured by Teijin DuPont Films Corp., 25 μm thick) serving as a protection film was laminated thereon, whereby a cladding layer forming resin film was obtained.

On this occasion, the thickness of the resin layer that is formed from the cladding layer forming resin varnish may be arbitrarily regulated by adjusting the gap of the coating machine. The thickness thereof is described later.

### Preparation of Core Layer Forming Resin Film

A core layer forming resin varnish was prepared substantially similarly to the method and conditions of preparing the aforementioned cladding layer forming resin varnish, except that: (A) as a base polymer, 26 parts by mass of a phenoxy resin (“PHENOTOHTO YP-70”, manufactured by Tohto Kasei Co., Ltd.); (B) as a photo-polymerizing compound, 36 parts by mass of 9, 9-bis[4-(2-acryloyloxyethoxy) phenyl] fluorene (“A-BPEF”, manufactured by Shin-Nakamura Chemical Co., Ltd.) and 36 parts by mass of a bisphenolA epoxyacrylate (“EA1020”, manufactured by Shin-Nakamura Chemical Co., Ltd.); (C) as a photo-polymerization initiator, 1 part by mass of bis(2, 4, 6-trimethylbenzoyl) phenylphosphine oxide (“IRGACURE 819”, manufactured by BASF Japan Ltd.) and 1 parts by mass of 1-[4-(2-hydroxyethoxy) phenyl]-2-hydroxy-2-methyl-1-propane-1-on (“IRGACURE 2959”, manufactured by BASF Japan Ltd.); and as an organic solvent, 40 parts by mass of propylene glycol monomethylether acetate were used. After that, under the same method and conditions as above, pressure filtration and vacuum degassing were performed.

The core layer forming resin varnish obtained above was coated and dried on the non-treated face of a PET film (“COSMOSHINE A1517”, manufactured by Toyobo Co., Ltd., 16 μm thick) that serves as a supporting film in a manner substantially similarly to the method in the aforementioned manufacturing example. Then, a peeling PET film (“PUREX A31”, manufactured by Teijin DuPont Films Corp., 25 μm thick) that serves as a protection film was laminated thereon in a manner that the peeling face thereof faces to the resin side, whereby a core layer forming resin film was obtained.

On this occasion, the thickness of the resin layer that is formed from the core layer forming resin varnish may be arbitrarily regulated by adjusting the gap of the coating machine.

Manufacturing Example of Optical Waveguide in Accordance with First Embodiment

Step of Preparing Substrate; Preparation of Substrate and Step A1

A polyimide film 100 mm×100 mm (“KAPTON EN”, manufactured by DU PONT-TORAY CO., LTD., 12.5 μm thick) that serves as the substrate sheet 12 was used. On one of the faces thereof, a PET film that has a removable adhesive layer (“PANAPROTECT ET-50 kB”, manufactured by PANAC Corp.) and serves as a temporary fixing sheet 8 was laminated with a roll laminator (“HLM-1500”, manufactured by Hitachi Chemical Technoplant Co., Ltd.) under the conditions: 0.4 MPa of pressure, 50° C. of temperature, and 0.2 m/min of lamination speed (see FIG. 2(a)).

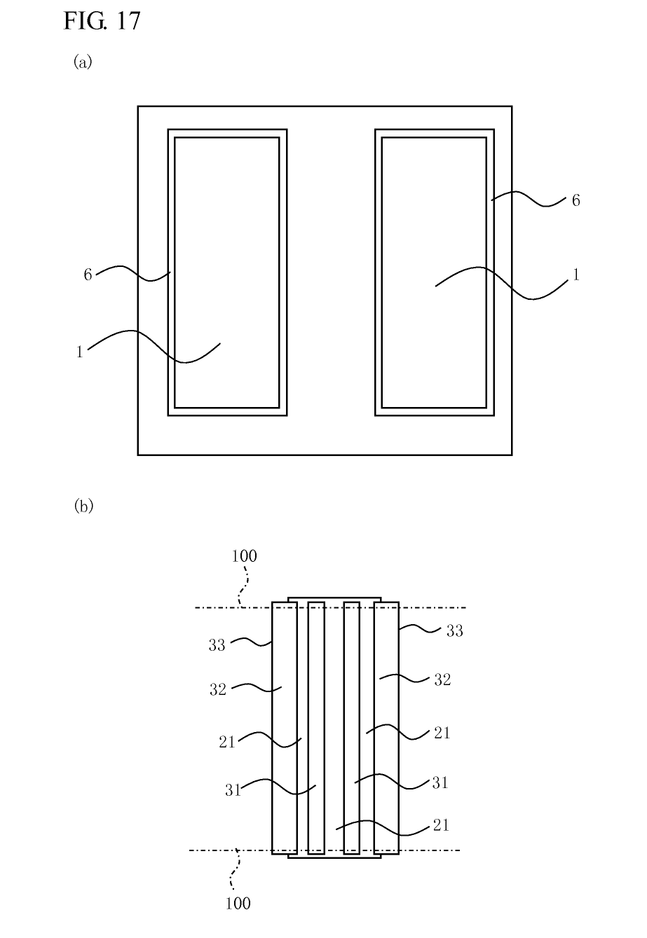

Then, with third harmonic of Nd-YAG laser (355 nm of wavelength), the substrate sheet 12 was subjected to shape-processing without cutting out the temporary fixing sheet 8, so that the substrate 1 (2950 μm×10 mm×2 parts) was formed. Note that, the space of the removed portion was 20 μm (see FIG. 2(b) and FIG. 17(a)).

Then, on the surface of the polyimide film, as a supporting substrate 6, a PET film having a removable adhesive layer (“PANAPROTECT ET-50 kB”, manufactured by PANAC Corp.) was laminated with a roll laminator (“HLM-1500”, manufactured by Hitachi Chemical Technoplant Co., Ltd.) under the conditions: 0.4 MPa of pressure, 50° C. of temperature, and 0.2 m/min of lamination speed (see FIG. 2(c)). Next, cutting margins remained between the temporary fixing sheet 8 and the substrate 1 were removed by peeling off (see FIG. 2(d)).

Step B1 of Forming Lower Cladding Pattern

From the side of the optical waveguide forming face 13 of the substrate 1, the protection film of the 27 μm thick cladding layer forming resin film that was obtained as descried above was peeled off. Then, after vacuum drawing to 500 Pa or lower with a vacuum-pressing laminator (“MVLP-500”, manufactured by MEIKI CO., LTD.), lamination was performed under the conditions: 0.4 MPa of pressure, 110° C. of temperature, and 30 seconds of pressing time. Successively, with an UV light exposure machine (“EXM-1172”, manufactured by ORC MANUFACTURING CO., LTD.), the center of the aperture and the center of the substrate 1 were aligned through a negative photomask having an aperture (2920 μm×9.950 mm×2 parts), and then UV light (365 nm of wavelength) was irradiated at 350 mJ/cm² from the supporting film side of the cladding layer forming resin film. After that, the supporting film was peeled off, and the lower cladding layer forming resin on the supporting substrate 6 was removed with a developer solution (1% potassium carbonate aqueous solution), and then water washing was performed. Furthermore, with the aforementioned UV light exposure machine, irradiation was performed at 3.0 J/cm². Heat drying at 170° C. for 1 hour and curing work were performed successively. The thickness of the lower cladding pattern 21 was 15 μm as measured from the surface of the substrate 1 (see FIG. 2(e)).

Step C1 of Forming Optical Signal Transmitting Core Pattern and Protruding Pattern

Then, from the side of the face on which the lower cladding pattern 21 was formed as above, after the protection film was peeled off, the 72 μm thick core layer forming resin film obtained above was laminated with a roll laminator (“HLM-1500”, manufactured by Hitachi Chemical Technoplant Co., Ltd.) under the conditions: 0.4 MPa of pressure, 50° C. of temperature, and 0.2 m/min of lamination speed. Then, after vacuum drawing to 500 Pa or lower with a vacuum-pressing laminator (“MVLP-500”, manufactured by MEIKI CO., LTD.), heat pressing was performed under the conditions: 0.4 MPa of pressure, 70° C. of temperature, and 30 seconds of pressing time.

Successively, a negative photomask is subjected to positioning in a manner that the aperture (150 μm×9.900 mm) of the protruding pattern 32 is aligned at a position where the substrate outer periphery 11 of long side (two sides) of the substrate 1 is held thereby. In addition, apertures (45 μm×9.900 mm) of the optical signal transmitting core pattern 31 are formed in 8 (eight) parts (abbreviated in 2 (two) parts, in the figure). The negative photomask is aligned in a manner that the apertures are positioned on the lower cladding pattern 21. Then, through the negative photomask, with the aforementioned UV light exposure machine, from the side of the supporting film, UV light (365 nm of wavelength) was irradiated at 0.81 J/cm². Post heating was performed at 80° C. for 5 minutes. After that, the PET film that serves as a supporting film was peeled off, and etching was performed with a developer solution (propylene glycol monomethylether acetate/N, N-dimethyl acetamide=8/2, by mass ratio). Then, washing was performed with a washing liquid (isopropanol), heat drying was performed at 100° C. for 10 minutes, so that the optical signal transmitting core pattern 31 and the protruding pattern 32 were formed (see FIG. 2(f)). The height of the resulting optical signal transmitting core pattern 31 from the surface of the lower cladding pattern 21 was 45 μm. The core width of the optical signal transmitting core pattern 31 was 45 μm. The height of the protruding pattern 32 from the surface of the supporting substrate 6 was 75 μm.

Step D1 of Forming Upper Cladding Pattern

The 97 μm thick cladding layer forming resin film obtained above was, after the protection film was peeled off and after vacuum drawing to 500 Pa or lower with a vacuum-pressing laminator (“MVLP-500”, manufactured by MEIKI CO., LTD.), subjected to lamination, over the optical signal transmitting core pattern 31 and the protruding pattern 32, by means of heat pressing under the conditions: 0.4 MPa of pressure, 110° C. of temperature, and 30 seconds of pressing time.

After that, the aperture center of a negative photomask that has apertures (2900 μm×9.950 mm×2 parts) and the center of the substrate 1 were aligned, and then UV light (365 nm of wavelength) was irradiated at 350 mJ/cm², with the UV light exposure machine above described, from the supporting film side of the cladding layer forming resin film. Then, the supporting film was peeled off. With a developer solution (1% potassium carbonate aqueous solution), the upper cladding layer forming resin on the supporting substrate 6 was removed. Then, water washing was performed. In addition, irradiation of 3.0 J/cm² was performed with the UV light exposure machine described above, then heat drying at 170° C. for 1 hour and curing work were performed. The thickness of the upper cladding pattern 41 was 87.5 μm as measured from the surface of the substrate 1 (see FIG. 2(g)).

Step E1 of Removing Supporting Substrate

The supporting substrate 6 was peeled off from the substrate 1 and protruding pattern 32 of the resulting optical waveguide at the interface thereof, so that the supporting substrate 6 was removed by peeling (see FIG. 2(h)).

In the resulting waveguide, the distance between the outer peripheral walls 33 of the protruding patterns 32 that face to each other was 2.998 mm. In the resulting optical waveguide, the height from the bottom face of the substrate 1 to the core center of the optical signal transmitting core pattern 31 was 50 μm. The total thickness of the optical waveguide including the substrate 1 was 100 μm. The pitch of the optical signal transmitting core pattern 31 was 250 μm. In the substrate 1, the angle between the optical waveguide forming face 13 and the outer peripheral wall 33 was 90°. When a G150 optical fiber array 8CH (250 μm of pitch) and the optical signal transmitting core pattern 31 were subjected to positional alignment, good alignment is achieved, whereby optical signals were transmitted satisfactorily.

Substrate Cutting

The resulting optical waveguide was cut in a direction parallel to the short side of the substrate 1, along a dicing processing line 100, with a dicing saw (“DAC552”, manufactured by DISCO Corp.), in a manner that the length of the optical signal transmitting core pattern 31 becomes 9.8 mm, and the end faces thereof were smoothed (see FIG. 17(b); the upper cladding pattern 41 is not shown in the figure).

The resulting optical waveguide was mounted on the optical waveguide fixing portion of the connector 9 (“PMT CONNECTOR”, manufacture by Hakusan Mfg. Co., Ltd.); the shape of the optical waveguide fitting portion is 3.0 mm in width and 100 μm in height). With a positional displacement of 1 μm between the center of the outer shape and the array center (center position between 1CH and 8CH) of the optical signal transmitting core pattern 31, mounting was achieved in success (see FIG. 2(i)). The optical waveguide was hardly broken even if the upper cladding pattern side thereof was folded inward with a bending radium of 5 mm.

### Example 2

### Manufacturing Example of Optical Waveguide in Accordance with Second Embodiment

Except changes described below, an optical waveguide was manufactured substantially similarly to Example 1.

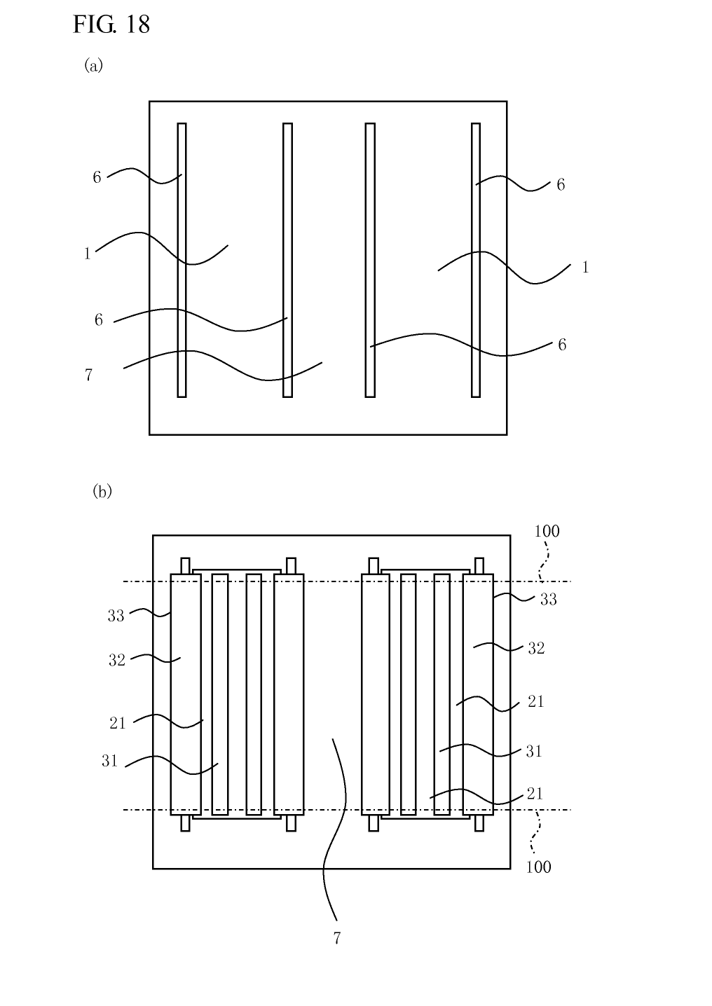

Step of preparing substrate: in the step A2 of preparing a substrate, by forming a pair of slits in two positions in a manner that the width of the substrate 1 becomes 2950 μm, a substrate in which the substrate 1 and the peeling substrate 7 were partly connected to each other was manufactured. (see FIG. 18(a)).

The thickness of the lower cladding layer forming resin was selected to be 17.5 μm, the thickness of the core layer forming resin was selected to be 45 μm, and the thickness of the upper cladding layer forming resin was selected to be 70 μm. The protruding pattern 32 holds the substrate outer periphery 11 and was formed on the substrate 1 and the peeling substrate 7. After the upper cladding pattern 41 was formed, the supporting substrate 6 was removed by peeling. Then, in a direction parallel to the short side of the substrate 1, with a dicing saw (“DAC552”, manufactured by DISCO Corp.), in a manner that the length of the optical signal transmitting core pattern 31 becomes 9.8 mm, along the dicing processing line 100, the peeling substrate 7 and the substrate 1 were cut out, and at the same time, the end faces thereof were smoothed (see FIG. 18(b); the upper cladding pattern 41 is not shown in the figure). At this time, the peeling substrate 7 and the substrate 1 are connected to each other through the protruding pattern 32. Finally, the peeling substrate 7 was removed by peeling. In this way, the optical waveguide shown in FIG. 3 was manufactured.

In the resulting waveguide, the distance between the outer peripheral walls 33 of the protruding patterns 32 that face to each other was 2.998 mm. In the resulting optical waveguide, the height from the bottom face of the substrate 1 to the core center of the optical signal transmitting core pattern 31 was 50 μm. The total thickness of the optical waveguide including the substrate 1 was 100 μm. The pitch of the optical signal transmitting core pattern 31 was 250 μm. In the substrate 1, the angle between the optical waveguide forming face 13 and the outer peripheral wall 33 was 90°. When a G150 optical fiber array 8CH (250 μm of pitch) and the optical signal transmitting core pattern 31 were subjected to positional alignment, good alignment was achieved, whereby optical signals were transmitted satisfactorily.

The resulting optical waveguide was mounted on the optical waveguide fixing portion of the connector 9 (“PMT CONNECTOR” manufacture by Hakusan Mfg. Co., Ltd.); the shape of the optical waveguide fitting portion is 3.0 mm in width and 100 μm in height). With a positional displacement of 1 μm between the center of the outer shape and the array center of the optical signal transmitting core pattern 31, mounting was achieved in success (see FIG. 4(i)). The optical waveguide was hardly broken even if the upper cladding pattern side thereof was folded inward with a bending radium of 5 mm.

### Example 3

### Manufacturing Example of Optical Waveguide in Accordance with Second Embodiment

Except changes described below, an optical waveguide was manufactured substantially similarly to Example 2.

As a composite of the substrate sheet 12 and the supporting substrate 6, a polyimide film with copper foil (12 μm thick copper foil (“NA-DFF”, manufactured by MITSUI MINING & SMELTING CO., LTD.) and 12.5 μm thick polyimide (“UPIREX VT”, manufactured by UBE-NITTO KASEI CO., LTD.) were used. Shape-processing was performed with Nd-YAG laser while the metal foil was not pierced.

Except that the copper foil that serves as the supporting substrate 6 was removed by etching with a ferric chloride aqueous solution after the upper cladding pattern 41 was formed, an optical waveguide was manufactured in a manner substantially similarly to Example 2.

In the resulting optical waveguide, the height from the bottom face of the substrate 1 to the core center of the optical signal transmitting core pattern 31 was 50 μm. The total thickness of the optical waveguide including the substrate 1 was 100 μm. The pitch of the optical signal transmitting core pattern 31 was 250 μm. In the substrate 1, the angle between the optical waveguide forming face 13 and the outer peripheral wall 33 was 90°. When a G150 optical fiber array 8CH (250 μm of pitch) and the optical signal transmitting core pattern 31 were subjected to positional alignment, good alignment was achieved, whereby optical signals were transmitted satisfactorily.

The resulting optical waveguide was mounted on the optical waveguide fixing portion of the connector 9 (“PMT CONNECTOR” manufacture by Hakusan Mfg. Co., Ltd.); the shape of the optical waveguide fitting portion is 3.0 mm in width and 100 μm in height). With a positional displacement of 1 μm between the center of the outer shape and the array center of the optical signal transmitting core pattern 31, mounting was achieved in success (see FIG. 4(i)). The optical waveguide was hardly broken even if the upper cladding pattern side thereof was folded inward with a bending radium of 5 mm.

### Example 4

### Manufacturing Example of Optical Waveguide in Accordance with Third Embodiment

Except changes described below, an optical waveguide was manufactured substantially similarly to Example 1.

Before the substrate sheet 12 and the supporting substrate 6 are laminated, on one of the faces of the substrate sheet 12, a 15 μm thick lower cladding layer forming resin film was laminated. Then, with the aforementioned exposure machine, UV light (355 nm) was irradiated at 3.0 J/cm², and heat curing at 170° C. for 1 hour was performed. After that, the temporary fixing sheet 8 was formed on the lower cladding layer 2 forming face. Then, similarly to Example 1, with Nd-YAG laser, the substrate 1 and the lower cladding layer 2 were subjected to shape-processing without cutting out the temporary fixing sheet 8. After that, the supporting substrate 6 similar to the one in Example 1 was laminated on the substrate 1, then the temporary fixing sheet 8 and the cutting margin between the substrate 1 were removed by peeling.

Core patterns were formed in a manner similarly to Example 1.

Except that the aperture of the negative photomask was selected to be 2970 μm×9.950 mm×2 parts in the process of forming the upper cladding pattern 41, an optical waveguide was manufactured in a similar manner.

In the resulting optical waveguide, the height from the bottom face of the substrate 1 to the core center of the optical signal transmitting core pattern 31 was 50 μm. The total thickness of the optical waveguide including the substrate 1 was 100 μm. The pitch of the optical signal transmitting core pattern 31 was 250 μm. In the substrate 1, the angle between the optical waveguide forming face 13 and the outer peripheral wall 33 was 90°. When a G150 optical fiber array 8CH (250 μm of pitch) and the optical signal transmitting core pattern 31 were subjected to positional alignment, good alignment was achieved, whereby optical signals were transmitted satisfactorily.

The resulting optical waveguide was mounted on the optical waveguide fixing portion of the connector 9 (“PMT CONNECTOR” manufacture by Hakusan Mfg. Co., Ltd.); the shape of the optical waveguide fitting portion is 3.0 mm in width and 100 μm in height). With a positional displacement of 1 μm between the center of the outer shape and the array center of the optical signal transmitting core pattern 31, mounting was achieved in success (see FIG. 6(i)). The optical waveguide was hardly broken even if the upper cladding pattern side thereof was folded inward with a bending radium of 5 mm.

### Example 5

### Manufacturing Example of Optical Waveguide in Accordance with Forth Embodiment

Except changes described below, an optical waveguide was manufactured substantially similarly to Example 1.

An optical waveguide was manufactured in a manner substantially similarly to Example 1, except that the aperture of the negative photomask in the lower cladding pattern 21 was selected to be 2970 μm×9.950 mm×2 parts.

In the resulting optical waveguide, the height from the bottom face of the substrate 1 to the core center of the optical signal transmitting core pattern 31 was 50 μm. The total thickness of the optical waveguide including the substrate 1 was 100 μm. The pitch of the optical signal transmitting core pattern 31 was 250 μm. In the substrate 1, the angle between the optical waveguide forming face 13 and the outer peripheral wall 33 was 90°. When a G150 optical fiber array 8CH (250 μm of pitch) and the optical signal transmitting core pattern 31 were subjected to positional alignment, good alignment was achieved, whereby optical signals were transmitted satisfactorily.

The resulting optical waveguide was mounted on the optical waveguide fixing portion of the connector 9 (“PMT CONNECTOR” manufacture by Hakusan Mfg. Co., Ltd.); the shape of the optical waveguide fitting portion is 3.0 mm in width and 100 μm in height). With a positional displacement of 1 μm between the center of the outer shape and the array center of the optical signal transmitting core pattern 31, mounting was achieved in success (see FIG. 8(i)). The optical waveguide was hardly broken even if the upper cladding pattern side thereof was folded inward with a bending radium of 5 mm.

### Example 6

An optical waveguide was manufactured similarly, except that, in Example 4, the width of the protruding pattern 32 was selected to be 50 μm (the distance between the outer peripheral walls 33 that face to each other is 3052 μm) and that the substrate outer periphery 11 was not held.

In the resulting optical waveguide, the height from the bottom face of the substrate 1 to the core center of the optical signal transmitting core pattern 31 was 50 μm. The total thickness of the optical waveguide including the substrate 1 was 100 μm. The pitch of the optical signal transmitting core pattern 31 was 250 μm. In the substrate 1, the angle between the optical waveguide forming face 13 and the outer peripheral wall 33 was 90°. When a G150 optical fiber array 8CH (250 μm of pitch) and the optical signal transmitting core pattern 31 were subjected to positional alignment, good alignment was achieved, whereby optical signals were transmitted satisfactorily.

The resulting optical waveguide was mounted on the optical waveguide fixing portion of the connector 9 (“PMT CONNECTOR” manufacture by Hakusan Mfg. Co., Ltd.); the shape of the optical waveguide fitting portion is 3.06 mm in width (the width was widened from 3.0 to 3.06 by carving out) and 100 μm in height). Although the protruding pattern 32 was chipped, but, with a positional displacement of 1 μm between the center of the outer shape and the array center of the optical signal transmitting core pattern 31, mounting was achieved in success.

### Comparative Example 1

While the thickness of the lower cladding layer forming resin film in Example 2 was selected to be 27.5 μm, and films that have thicknesses similar to those in Example 2 were used as the upper cladding layer 4 and the core layer forming resin film, an optical waveguide was formed on the supporting substrate 6 without using the substrate 1. Whereby, an optical waveguide having no substrate 1 was manufactured.

In the step E1, when the supporting substrate 6 was peeled off, cracks were developed in the protruding pattern 32. Peeling was not satisfactorily performed.

In the resulting optical waveguide, the height from the bottom face of the substrate 1 to the core center was 50 μm. The total thickness of the optical waveguide including the substrate 1 was 100 μm. The pitch of the optical signal transmitting core pattern 31 was 247 μm.

When a G150 optical fiber array 8CH (250 μm of pitch) and the optical signal transmitting core pattern 31 were subjected to positional alignment, pitches were out of alignment. Whereby, optical signals were not satisfactorily transmitted.

The resulting optical waveguide was mounted on the optical waveguide fixing portion of the connector 9 (“PMT CONNECTOR” manufacture by Hakusan Mfg. Co., Ltd.); the shape of the optical waveguide fitting portion is 3.0 mm in width and 100 μm in height). A part of the protruding pattern 32 was peeled off and dropped. When the upper cladding pattern side was folded inward with a bending radium of 5 mm, the optical waveguide was broken.

### Comparative Example 2

In Example 2, on the substrate sheet 12, the lower cladding layer 2, the optical signal transmitting core pattern 31, and the upper cladding layer 4 (the lower cladding layer 2 and the upper cladding layer 4 are not patterned) were formed. The four sides of the substrate 1 in the optical waveguide were subjected to cutting with a dicing saw (“DAC552”, manufactured by DISCO Corp.) in a manner that the length of the optical signal transmitting core pattern 31 becomes 9.8 mm, and the end faces thereof were smoothed.

In the resulting optical waveguide, the positional displacement between the center of the outer shape and the array center of the optical signal transmitting core pattern 31 was 8 μm. Satisfactory positional alignment was not achieved.

### Example 7

### Manufacturing Example of Optical Waveguide in Accordance with Sixth Embodiment

Forming Lower Cladding Pattern

As the substrate 1, a 100 mm×100 mm polyimide film (“KAPTON EN” of polyimide, manufactured by DU PONT-TORAY CO., LTD., 12.5 μm thick) was used. After the protection film of the 15 μm thick cladding layer forming resin film above obtained was peeled off, vacuum drawing to 500 Pa or lower was performed with a vacuum-pressing laminator (“MVLP-500”, manufactured by MEIKI CO., LTD.). Then, heat pressing was performed under the conditions of 0.4 MPa of pressure, 110° C. of temperature, and 30 seconds of pressing time so as to laminate the film on the substrate 1. Then, with a UV light exposure machine (“EXM-1172”, manufactured by ORC MANUFACTURING CO., LTD.), irradiation was performed at 3.0 J/cm². Heat drying at 170° C. for 1 hour and curing work were performed successively. The thickness of the lower cladding layer 2 was 15 μm as measured from the surface of the substrate 1 (see FIG. 12(a)).

Forming protruding pattern and optical signal transmitting core pattern After the protection film was peeled off, from the side of the lower cladding layer 2 forming face, the 45 μm thick core layer forming resin film obtained above was laminated with a roll laminator (“HLM-1500”, manufactured by Hitachi Chemical Technoplant Co., Ltd.) under the conditions: 0.4 MPa of pressure, 50° C. of temperature, and 0.2 m/min of lamination speed. Then, after vacuum drawing to 500 Pa or lower was performed with a vacuum-pressing laminator (“MVLP-500”, manufactured by MEIKI CO., LTD.), heat pressing was performed under the conditions of 0.4 MPa of pressure, 70° C. of temperature, and 30 seconds of pressing time.

Subsequently, through a negative photomask in which an aperture (150 μm×10 cm) for forming the protruding pattern 32 and another aperture (45 μm×10 cm) for forming the optical signal transmitting core pattern 31 were disposed at 8 parts with a pitch of 250 μm, from the supporting film side, with the aforementioned UV light exposure machine, UV light (365 nm of wavelength) was irradiated at 0.8 J/cm², and post heating was performed at 80° C. for 5 minutes. After that, the PET film that serves as the supporting film was peeled off, and etching was performed with a developer solution (propylene glycol monomethylether acetate/N, N-dimethyl acetamide=8/2 by mass). Then, washing was performed with a washing liquid (isopropanol) and heat drying was performed at 100° C. for 10 minutes, so that the optical signal transmitting core pattern 31 and the protruding pattern 32 were formed (see FIG. 12(b)). The thickness of the resulting optical signal transmitting core pattern 31 was 45 μm from the surface of the lower cladding layer 2. The core width of the optical signal transmitting core pattern 31 was 45 μm. The thickness of the protruding pattern 32 was 45 μm from the surface of the lower cladding layer 2.

Forming Upper Cladding Layer

After the protection film was peeled off and after vacuum drawing to 500 Pa or lower with a vacuum-pressing laminator (“MVLP-500”, manufactured by MEIKI CO., LTD.), the 61 μm thick cladding layer forming resin film obtained above was laminated over the resulting optical signal transmitting core pattern 31 and protruding pattern 32 by means of heat pressing under the conditions: 0.4 MPa of pressure, 110° C. of temperature, and 30 seconds of pressing time.

Successively, a negative photomask having an aperture (2900 μm×10 cm) was aligned in a manner that the long side of the aperture was positioned over the protruding pattern 32 that was formed before. Then, with an UV light exposure machine described above, from the supporting film side of the cladding layer forming resin film, UV light (365 nm of wavelength) was irradiated at 350 mJ/cm². After that, the supporting film was peeled off; the uncured upper cladding layer forming resin was removed with a developer solution (1% potassium carbonate aqueous solution); and then, water washing was performed. Furthermore, with the UV light exposure machine described above, irradiation was performed at 3.0 J/cm². After that, heat drying at 170° C. for 1 hour and curing work were performed. The total thickness of the resulting optical waveguide was 100 μm (see FIG. 12(c)).

Removing Substrate

From the side of the substrate 1 in the resulting optical waveguide, with a dicing saw (“DAC552”, manufactured by DISCO Corp.) equipped with a rectangular dicing blade (100 μm of blade width), after positional alignment was performed in a manner that the one end of the protruding pattern 32 (in a direction to which no optical signal transmitting core pattern 31 exists) was held, cutting was performed at a cutting depth of 28 μm (see FIG. 12(d)). At the same time, in a manner that the optical signal transmitting core pattern 31 was exposed to the end face, both faces were formed at a length of 50 mm.

In the resulting optical waveguide, the distance between the outer peripheral walls 33 of the protruding patterns 32 that face to each other was 2.998 mm. In the resulting optical waveguide, the height from the bottom face of the substrate 1 to the core center of the optical signal transmitting core pattern 31 was 50 μm. The total thickness of the optical waveguide including the substrate 1 was 100 μm. The pitch of the optical signal transmitting core pattern 31 was 250 μm. In the substrate 1, the angle between the optical waveguide forming face and the outer peripheral wall 33 was 90°. The thickness of the outer peripheral wall 33 was 44.5 μm. In the protruding portion 5 that protrudes out of the substrate 1, the length of the one end thereof was 30 μm and that of another end was 15 μm.

Fabricating Optical Device

The resulting optical waveguide was mounted on the optical waveguide fixing portion of the connector 9 (“PMT CONNECTOR”, manufacture by Hakusan Mfg. Co., Ltd.); the shape of the optical waveguide fitting portion is 3.0 mm in width and 100 μm in height). With a positional displacement of 1 μm between the center of the outer shape and the array center of the optical signal transmitting core pattern 31, mounting was achieved in success.

When a separate connector having a G150 optical fiber array 8CH (250 μm of pitch) and the optical signal transmitting core pattern 31 were subjected to positional alignment, good alignment was achieved, whereby optical signals were transmitted satisfactorily.

### Example 8

### Manufacturing Example of Optical Waveguide in Accordance with Seventh Embodiment

An optical waveguide was manufactured in a similar manner, except that, in Example 1, the lower cladding layer 2 was patterned with the negative photomask that was used for the upper cladding layer 4, the thickness of the core forming resin film was selected to be 60 μm, and the thickness of the upper cladding layer forming resin film was selected to be 74 μm (see FIG. 14(c)).

Removing Substrate

From the side of the substrate 1 in the resulting optical waveguide, with a dicing saw similar to the one used in Example 1, after positional alignment was performed in a manner that the one end of the protruding pattern 32 (in a direction to which no optical signal transmitting core pattern 31 exists) was held, cutting was performed at a cutting depth of 13 μm (see FIG. 14(d)). At the same time, in a manner that the optical signal transmitting core pattern 31 was exposed to the end face, both end faces were formed at a length of 50 mm.

In the resulting optical waveguide, the distance between the outer peripheral walls 33 of the protruding patterns 32 that face to each other was 2.996 mm. In the resulting optical waveguide, the height from the bottom face of the substrate 1 to the core center of the optical signal transmitting core pattern 31 was 50 μm. The total thickness of the optical waveguide including the substrate 1 was 100 μm. The pitch of the optical signal transmitting core pattern 31 was 250 μm. In the substrate 1, the angle between the optical waveguide forming face and the outer peripheral wall 33 was 90°. The thickness of the outer peripheral wall 33 was 59.5 μm. In the protruding portion 5 that protrudes out of the substrate 1, the length of the one end thereof was 40 μm and that of another end was 30 μm.

Fabricating Optical Device

The resulting optical waveguide was mounted on the optical waveguide fixing portion of the connector 9 (“PMT CONNECTOR”, manufacture by Hakusan Mfg. Co., Ltd.); the shape of the optical waveguide fitting portion is 3.0 mm in width and 100 μm in height). With a positional displacement of 1 μm between the center of the outer shape and the array center of the optical signal transmitting core pattern 31, mounting was achieved in success.

When a separate connector having a G150 optical fiber array 8CH (250 μm of pitch) and the optical signal transmitting core pattern 31 were subjected to positional alignment, good alignment was achieved, whereby optical signals were transmitted satisfactorily.

### Example 9

### Manufacturing Example of Optical Waveguide in Accordance with Eighth Embodiment

After the upper cladding pattern 41 was formed in a manner substantially similarly to Example 8, with the aforementioned dicing saw equipped with a dicing blade having an angle of 90°, cutting was performed to a depth at which the protruding pattern 32 appears in the one inclined cut face (see FIG. 16(d)). At the same time, with a dicing blade similar to the one used in Example 2, in a manner that the optical signal transmitting core pattern 31 was exposed in the end face, both end faces were formed at a length of 50 mm.

In the resulting optical waveguide, the distance between the outer peripheral walls 33 of the protruding patterns 32 that face to each other was 2.996 mm. In the resulting optical waveguide, the height from the bottom face of the substrate 1 to the core center of the optical signal transmitting core pattern 31 was 50 μm. The total thickness of the optical waveguide including the substrate 1 was 100 μm. The pitch of the optical signal transmitting core pattern 31 was 250 μm. In the substrate 1, the angle between the optical waveguide forming face and the outer peripheral wall 33 was 90°. The thickness of the outer peripheral wall 33 was 58 μm at both ends thereof. In the protruding portion 5 that protrudes out of the substrate 1, the length of both ends thereof was 1.5 μm.

Fabricating Optical Device

The resulting optical waveguide was mounted on the optical waveguide fixing portion of the connector 9 (“PMT CONNECTOR”, manufacture by Hakusan Mfg. Co., Ltd.); the shape of the optical waveguide fitting portion is 3.0 mm in width and 100 μm in height). With a positional displacement of 1 μm between the center of the outer shape and the array center of the optical signal transmitting core pattern 31, mounting was achieved in success.

When a separate connector having a G150 optical fiber array 8CH (250 μm of pitch) and the optical signal transmitting core pattern 31 were subjected to positional alignment, good alignment was achieved, whereby optical signals were transmitted satisfactorily.

### Comparative Example 3

In Example 7, on the substrate 1, the lower cladding layer 2, the optical signal transmitting core pattern 31 (no protruding pattern is formed), and the upper cladding layer 4 (the lower cladding layer 2 and the upper cladding layer 4 are not patterned) were formed. The four sides of the substrate 1 in the optical waveguide were subjected to cutting with a dicing saw (“DAC552”, manufactured by DISCO Corp.) in a manner that the length of the optical signal transmitting core pattern 31 becomes 50 mm, and the end faces thereof were smoothed.

In the resulting optical waveguide, the positional displacement between the center of the outer shape and the array center of the optical signal transmitting core pattern 31 was 8 μm. Satisfactory positional alignment to an external light receiving and emitting member was not achieved.

### INDUSTRIAL APPLICABILITY

The optical waveguide of the present invention provides easily a high-accuracy positional alignment to a separate member such as an optical fiber connector, whereby an excellent optical signal transmission efficiency is provided. So that, the optical waveguide is applicable in a wide application field including various kinds of optical devices and optical interconnections.

### REFERENCE SIGNS LIST

1 . . . Substrate
11 . . . Substrate outer periphery
12 . . . Substrate sheet
13 . . . Optical waveguide forming face
2 . . . Lower cladding layer
21 . . . Lower cladding pattern
22 . . . End part of lower cladding pattern
31 . . . Optical signal transmitting core pattern
32 . . . Protruding pattern
33 . . . Outer peripheral wall
4 . . . Upper cladding layer
41 . . . Upper cladding pattern
42 . . . End part of upper cladding pattern
5 . . . Protruding portion
6 . . . Supporting substrate
7 . . . Peeling substrate
8 . . . Temporary fixing sheet
9 . . . Connector
60 . . . Removing portion
100 . . . Dicing processing line

1. An optical waveguide, comprising:
a substrate;
a lower cladding layer, being formed on the substrate;
an optical signal transmitting core pattern and a protruding pattern, being formed on the lower cladding layer; and
an upper cladding layer, being formed in a manner that the upper cladding layer covers the optical signal transmitting core pattern in association with the lower cladding layer,
wherein,
the protruding pattern has an outer peripheral wall that protrudes out of the substrate, the lower cladding layer, and the upper cladding layer in a substrate outer periphery direction.

2. The optical waveguide according to claim 1,
wherein,
the outer peripheral wall is approximately perpendicular to the optical waveguide forming face.

3. The optical waveguide according to claim 1,
wherein,
the protruding pattern holds the substrate outer periphery.

4. The optical waveguide according to claim 1,
wherein,
the lower cladding layer is a patterned lower cladding pattern and the end part of the lower cladding pattern is held by the protruding pattern.

5. The optical waveguide according to claim 1,
wherein,
the upper cladding layer is a patterned upper cladding pattern and the end part of the upper cladding pattern is held by the protruding pattern.

6. The optical waveguide according to claim 1,
wherein,
the bottom face of the protruding pattern is formed on actually the same plane of the rear side of the optical waveguide forming face, or not on the rear side of the optical waveguide forming face but on the side of the optical waveguide forming face.

7. An optical waveguide manufacturing method, comprising:
a step A1 of forming a substrate on a part of a supporting substrate;
a step B1 of forming a lower cladding pattern on the substrate;
a step C1 of forming the protruding pattern on the substrate, the lower cladding pattern, and the surface of the supporting substrate by means of photolithographic processing in a manner that the substrate outer periphery is held;
a step D1 of forming an upper cladding pattern at a position where the optical signal transmitting core pattern is embedded and the end part thereof is held by the protruding pattern; and
a step E1 of removing the supporting substrate.

8. An optical waveguide manufacturing method, comprising:
a step A2 of not only forming a substrate on a part of a supporting substrate but also forming a peeling substrate on another part nearby the substrate;
a step B1 of forming a lower cladding pattern on the substrate;
a step C2 of forming the protruding pattern on the substrate, the lower cladding pattern, the surface of the supporting substrate, and the surface of the peeling substrate by means of photolithographic processing in a manner that the substrate outer periphery is held;
a step D1 of forming an upper cladding pattern at a position where the optical signal transmitting core pattern is embedded and the end part thereof is held by the protruding pattern; and
a step E1 of removing the supporting substrate.

9. The optical waveguide manufacturing method according to claim 7, comprising in order:
prior to the step A1 or the step A2,
a step of laminating a substrate sheet on a temporary fixing sheet and performing shape-processing of the substrate sheet into the shape of the substrate without cutting out the temporary fixing sheet;
a step of laminating the supporting substrate on the surface of the substrate sheet; and
a step of removing the temporary fixing sheet.

10. The optical waveguide manufacturing method according to claim 7,
wherein,
in the step C1 and the step C2, at the same time when the protruding pattern is formed, an optical signal transmitting core pattern is formed on the lower cladding pattern.

11. The optical waveguide manufacturing method according to claim 7, comprising:
a step F of removing the peeling substrate at the same time or after the step E1.

12. An optical waveguide manufacturing method, comprising:
a step B2 of forming a lower cladding layer on a substrate;
a step C3 of forming a stretching optical signal transmitting core pattern on the lower cladding layer and forming a protruding pattern in a manner that the optical signal transmitting core pattern is positioned therebetween;
a step D2 of forming an upper cladding pattern in a manner that, among the side faces of the protruding pattern, a side face that does not face to the side face of the optical signal transmitting core pattern is exposed and that the optical signal transmitting core pattern is embedded; and
a step E2 of removing the substrate and lower cladding layer under the protruding pattern, or removing the substrate.

13. An optical waveguide manufacturing method, comprising:
a step B1 of forming a lower cladding pattern on a substrate;
a step C4 of forming a stretching optical signal transmitting core pattern on the lower cladding pattern and forming a protruding pattern on the substrate and/or the lower cladding pattern in a manner that the optical signal transmitting core pattern is positioned therebetween:
a step D2 of forming an upper cladding pattern in a manner that, among the side faces of the protruding pattern, a side face that does not face to the side face of the optical signal transmitting core pattern is exposed and that the optical signal transmitting core pattern is embedded; and
a step E3 of removing the substrate and lower cladding pattern under the protruding pattern, or removing the substrate.

14. The optical waveguide manufacturing method according to claim 13,
wherein,
the protruding pattern is formed in a manner that the end part of the lower cladding pattern is held.

15. The optical waveguide manufacturing method according to claim 12,
wherein,
the optical signal transmitting core pattern and the protruding pattern are formed at the same time.

16. The optical waveguide manufacturing method according to claim 12,
wherein,
the optical signal transmitting core pattern and the protruding pattern are formed by means of photolithographic processing.

17. The optical waveguide manufacturing method according to claim 12,
wherein,
the upper cladding pattern is formed by means of photolithographic processing.

18. The optical waveguide manufacturing method according to claim 12,
wherein,
in the step E2 or the step E3, in the protruding pattern, a side face that is not covered with the upper cladding pattern is served as an outer peripheral wall of the optical waveguide.

19. The optical waveguide manufacturing method according to claim 12,
wherein,
in the step E2 or the step E3, removing is performed by means of dicing processing.

20. The optical waveguide manufacturing method according to claim 12,
wherein,
in the step E2 or the step E3, dicing processing is performed in a manner that resulting cross section has an approximately rectangular or triangular shape.

21. The optical waveguide manufacturing method according to claim 12,
wherein,
in the step E2 or the step E3, under the protruding pattern, at least a part of the substrate and/or the lower cladding pattern remains.

22. An optical module, wherein the optical waveguide according to claim 1 and a connector are fitted to each other by using an outer peripheral wall of the protruding pattern.

23. The optical waveguide manufacturing method according to claim 8, comprising in order:
prior to the step A1 or the step A2,
a step of laminating a substrate sheet on a temporary fixing sheet and performing shape-processing of the substrate sheet into the shape of the substrate without cutting out the temporary fixing sheet;
a step of laminating the supporting substrate on the surface of the substrate sheet; and
a step of removing the temporary fixing sheet.

24. The optical waveguiding manufacturing method according to claim 8,
wherein,
in the step C1 and the step C2, at the same time when the protruding pattern is formed, an optical signal transmitting core pattern is formed on the lower cladding pattern.

25. The optical waveguide manufacturing method according to claim 8, comprising:
a step F of removing the peeling substrate at the same time or after the step E1.

26. The optical waveguide manufacturing method according to claim 13,
wherein,
the optical signal transmitting core pattern and the protruding pattern are formed at the same time.

27. The optical waveguide manufacturing method according to claim 13,
wherein,
the optical signal transmitting core pattern and the protruding pattern are formed by means of photolithographic processing.

28. The optical waveguide manufacturing method according to claim 13,
wherein,
the upper cladding pattern is formed by means of photolithographic processing.

29. The optical waveguide manufacturing method according to claim 13,
wherein,
in the step E2 or the step E3, in the protruding pattern, a side face that is not covered with the upper cladding pattern is served as an outer peripheral wall of the optical waveguide.

30. The optical waveguide manufacturing method according to claim 13,
wherein,
in the step E2 or the step E3, removing is performed by means of dicing processing.

31. The optical waveguide manufacturing method according to claim 13,
wherein,
in the step E2 or the step E3, dicing processing is performed in a manner that resulting cross section has an approximately rectangular or triangular shape.

32. The optical waveguide manufacturing method according to claim 13,
wherein,
in the step E2 or the step E3, under the protruding pattern, at least a part of the substrate and/or the lower cladding pattern remains.
